(19) United States
(12) Patent Application Publication
(10) Pub. No.: US 2003/0134033 A1
(43) Pub. Date: Jul. 17, 2003

(54) Combinatorial screening/testing apparatus and method

(75) Inventors: Daniel L. Holguin, Fullerton, CA (US); Jay Akhave, Claremont, CA (US); Hsiao Ken Chuang, Arcadia, CA (US); Jessie Reaves, Los Angeles, CA (US); Carol A. Koch, San Gabriel, CA (US); Ali Mehrabi, Los Angeles, CA (US); Mark Licon, Diamond Bar, CA (US); Dennis Saunders, Orange, CA (US)

Correspondence Address: OPPENHEIMER WOLFF & DONNELLY LLP, 840 NEWPORT CENTER DRIVE, SUITE 700, NEWPORT BEACH, CA, 92660, US

(73) Assignee: Avery Dennison Corporation

(21) Appl. No.: 10/263,564

(22) Filed: Oct. 2, 2002

Related U.S. Application Data
(63) Continuation-in-part of application No. PCT/US00/29854, filed on Oct. 30, 2000.
(60) Provisional application No. 60/162,349, filed on Oct. 29, 1999.

(51) Int. Cl. B05D 1/00

(52) U.S. Cl. 427/8

(57) ABSTRACT

The present invention is directed generally to methods and apparatus for the efficient identification of components, formulations and materials produced therefrom. More particularly, the invention relates to automated apparatus and associated methods of utilizing arrays of materials for expeditious screening, testing, identification and optimization of formulations of materials and application parameters that provide novel materials having desired physical characteristics.

### RELATED APPLICATIONS

This application is a continuation-in-part of Avery Dennison Corporation's PCT Patent Application No. PCT/US00/29854, filed Oct. 30, 2000, which this application incorporates by reference. This application claims priority from U.S. Provisional Patent Application Serial No. 60/162,349, filed on Oct. 29, 1999, which this application also incorporates by reference.

### BACKGROUND OF THE INVENTION

1. Field of the Invention

The present invention relates generally to methods and apparatus for efficiently preparing, testing, and optimizing adhesive formulations. It also relates to developing pressure sensitive adhesive materials that have desired adhesion performance characteristics.

2. General Background and State of the Art

One of the most time consuming aspects in chemistry is preparing, developing and testing new formulations. The formulations may be typically developed using previously-known material formulations as a starting point “candidate components” for making the formulations are typically selected based on existing knowledge of which combinations of starting materials and/or components, in a particular formulation, are compatible with each other and work satisfactorily for particular applications and/or conditions. Different formulations are then prepared and tested, usually on a serial one-by-one basis, until particular combinations display the requisite formulation performance. Formulations for a wide variety of applications, such as electronics, packaging, adhesives, films, laminate constructs, labeling applications, and many others are typically formulated in this way.

As those skilled in the art will appreciate, this is a time-consuming process which results in only a pittance of new and useful materials having desired characteristics in a given period of time. Typically, a group is only able to screen/test a few materials per day, and often times only one or two. The entire process is laborious and by its nature amenable to long term sustained efforts without a commitment of dedicated resources in all phases of development.

This method usually involves numerous labor and time intensive experiments wherein a scientist or research group identifies candidate components and considers desired formulations to be made therefrom, prepares test samples under different experimental parameters and then goes about testing each of the different formulations made. They then determine the most suitable formulation by evaluating each of the different material formulations for the various property (or properties) that are desired, such as tack, adhesion, and cohesion, for pressure sensitive adhesives, for example.

Pressure sensitive adhesives (PSAs) are a distinct category of adhesive materials which, in dry (solvent free) form, are aggressively and permanently tacky at room temperature and firmly adhere to a variety of substrates upon mere contact, without need of more than finger or hand pressure. PSAs do not require activation by water, heat, or solvents; and have sufficient cohesive strength to be handled with the fingers. The primary mode of bonding for a PSA is not chemical or mechanical but, rather, a polar attraction to the substrate, and always requires initial pressure to achieve sufficient wet-out onto the surface to provide adequate adhesion.

Both rubber-based and acrylic-based PSAs are known. Whether a material will function as a PSA depends upon its composition and glass transition temperature (Tg). Although the upper limit of on Tg, for pressure-sensitive behavior depends on the application (use) temperature, most PSAs have a Tg less than 10° C., or even more common, less than 0° C. Thus, poly(methyl methacrylate) is not a PSA, but a copolymer of 2-ethylhexyl acrylate and acrylic acid is a PSA.

High performance PSAs are normally characterized by the ability to withstand creep or shear deformation at high loadings and/or high temperatures, while exhibiting adequate tack and peel adhesion properties. A high molecular weight provides the necessary cohesive strength and resistance to shear deformation, while a low modulus allows the polymer to conform to a substrate surface upon contact.

High molecular weight, or the physical effect of a high molecular weight, can be obtained by primary polymerization of monomers to form a backbone of long chain length, and/or by creating a high degree of inter chain hydrogen bonding, ionic association, or covalent crosslinking between polymer chains. For solvent-based adhesives, it is preferred to crosslink after polymerization (so-called ‘post-polymerization cure), which avoids processing difficulties such as coating a highly viscous polymer network. Post-crosslinking is also commonly used for water-based PSAs to enhance cohesive strength. Post-crosslinking is also sometimes used with hot melt PSAs, although radiation curing is more commonly employed with such systems, to avoid thermal cure during the coating process.

It has also long been recognized that adhesives can be enhanced by formulating components (i.e. blending polymers together or blending polymers with tackifying resins) to achieve an excellent balance of properties of tack, cohesion, and adhesion (especially to low surface energy polymeric substrates). As discussed above, those skilled in the art are typically limited by the tedious prior methodologies of material testing/screening. One limiting factor is the simple inability of the scientist to provide and test a plurality of differing material formulations in an efficient manner. There are prior art methods using a probe tester for testing material formulations, such as for testing adhesives, for example. Exemplary material or coating formulations are commonly investigated and tested to ascertain various characteristics, such as tack or “stickiness.” Some tests measure “tack force,” the maximum force recorded during the debonding of a probe from the test material. Other tests measure the energy dissipation during the debonding process. Unfortunately, these test methods do not yield any better definition of the tack of a particular material formulation than is typically provided by other conventional tack performance tests, such as loop tack, rolling ball tack, etc, as known to those in the art.

The preferred probe tester is the Avery Adhesion Tester (also known as AAT). As detailed in an article entitled “Avery Adhesive Test Yield More Performance Data than Traditional Probe” in Adhesives Age, September 1997, and incorporated herein by reference in its entirety, the Avery Adhesive Tester utilizes a spherical probe to record, test and analyze the entire stress-strain behavior of a material having a particular formulation. The spherical probe ensures contact consistency and the AAT test makes use of a mounting medium, such as double sided tape, to mount the test sample in order to minimize the effect of substrate stiffness on the testing of the subject formulated material. Many other types of test probes, such as the Polyken and flat test probes, among others, are known to those in the art and referenced in the article “Tape Measure” in the July 2000 issue of Adhesives Age, herein incorporated by reference in its entirety.

Avery Dennison Corporation has disseminated the AAT test to the industry, and several adhesives companies into their research programs have since incorporated it. As detailed in the above mentioned Adhesives Age article, an exemplary instrument which may be utilized to carry out AAT testing is a probe tester known commercially as the TA.XT2 texture analyzer (Stable Micro Systems Godalming, Surrey, England). The apparatus has a stainless steel spherical test probe which is connected to a force transducer and a computer. The computer is able to record forces acting on the probe. Utilizing a rotating screw driven by a step motor, the probe can be displaced. This displacement is measured through screw rotation. When testing a pressure sensitive adhesive (PSA), for example, the PSA is disposed upon a backing and bonded, adhesive side up, to a test platform and beneath the probe. During testing, displacement (distance) and forces acting on the probe may be recorded by a computer.

Typically, tests utilizing the AAT are designed to work on a sample of an adhesive or coating material, for example. Samples are typically about 1 cm×1 cm. Contact between the probe and the sample typically takes place at about a 1 mm² area within the sample of the material to be tested. The sample to be tested may be placed directly on a test platform or disposed onto a backing material, which is subsequently mounted onto the test platform. As known to those of skill in the art, a variety of materials may comprise the probe utilized in these various testing methods. Exemplary probe material includes glass, plastic, steel, aluminum, various acrylics and polymers, and a plethora of additional compositions, each chosen by a experiment designer in light of the contemplated applications of the material being screened/tested

Exemplary material screening/testing of new or known material formulations, utilizing the AAT test detailed above, includes the measurement of two processes: bonding and debonding. During the bonding process, the probe is displaced and compresses the material being tested, to a predetermined force (compression force). The test material deforms and wets the probe surface. The probe may dwell in this position for a predetermined amount of time with a constant compression force for a desired mount of time. During the debonding process, the probe is displaced and moves to separate itself from the test material, at a predetermined speed. Since the material has bonded to the surface of the probe, the material is elongated and will exert a tensile force on a transducer. This tensile force is characteristic of the physical properties of the probe utilized and the viscoelastic and cavitation properties of the material formulation undergoing testing. Eventually, the material will begin to separate from the probe. The debonding strength of the material is measured by the magnitude of the tensile force and duration time on the probe.

The exemplary AAT and associated components, measures the speed of displacement, forces acting upon, dwell times and distance traveled, for example, of the probe. The instrumentation is capable of providing digital outputs, including graphic profiles of the above-mentioned distances, speeds and forces. As detailed in the “Avery Adhesive Test Yields More Performance Data than Traditional Probe” article, exemplary characteristic parameters that tests utilizing the TA.XT2I texture analyzer displays and measures include the heights of graphic profiles of the test materials, as seen in FIG. 1. This exemplary profile displays a first and second peak (N (Newton)), area under the curve (energy in N·m; the area may be integrated) and displacement of the probe at debonding (mm). Measurements and analysis of these parameters may be provided in the form of an Excel or ASCII file, for example. As further discussed in the article, the AAT test has been shown to correlate well with other traditional testing methods, such as force peel tests, loop tack tests and may be used to gather data and investigate shear properties of the test material formulations.

One area of intensive research is the investigation of new materials, such as pressure sensitive adhesives. While there are many prior art methods for testing pressure sensitive materials, such as AAT testing, shear and loop testing, and 90° and 180° peel tests, these methodologies are time-consuming and typically allow a tester to test only a few new material formulations per day. By utilizing combinatorial design, formulation, compounding, coating, drying and testing/analysis techniques, the present invention can considerably increase the rate and ability of researchers to discover new materials having new formulations and desired properties. Thus, our apparatus and methods provide an acceleration of the rate at which new material formulations may be formulated, screened/tested for useful properties and optimized, advances the rate of material formulation and development and considerably shortens the product development time for new useful formulations.

### INVENTION SUMMARY

One aspect of the present invention is to provide a method for the rapid preparing and screening/testing of formulations for various properties. An exemplary method may be comprised of the steps of selecting starting components, designing experimental formulations comprised of said components, dispensing and mixing the starting components to provide a plurality of formulations having combinations of starting components and depositing the multiple formulations onto a substrate, exposing the deposited formulations to one or more processing conditions and then screening/testing, evaluating, and ranking the materials according to the absence or presence or level of some selected property.

Another aspect of the present invention is to utilize the AAT in combination with arrays of coatings of a plurality of formulations in order to efficiently screen/test the coated formulations, which may all be deposited upon identical substrates or substrates having differing compositions. A variety of deposition methods may be employed in depositing the plurality of materials having various formulations onto the substrate(s). These include, for example, spin casting, spin coating, dip coating, non-contact jet coating, photolithographic techniques with or without masks, sputtering techniques, spray coating or chemical vapor deposition. Material formulations may also be deposited onto the substrate in the form of droplets, aerosols, or gels and the like.

According to one embodiment of the present invention, a plurality of starting materials for various combinatorial formulations are dispensed into a plurality of sample receiving wells that are formed by placing an aperatured sheet onto at least one substrate, thus forming a multi-receptacle assembly. This assembly provides a method for keeping the individual formulations separated from one another and provides a barrier between the individual formulations to prevent mixing and cross-contamination. The aperatured sheet may be comprised of a flexible composition and have apertures of varying size and number.

Additionally, the substrate may also be flexible, thus providing a user with a multi-receptacle assembly that is flexible and able to conform to forces applied thereon. The multi-layered construction of this multi-receptacle assembly may provide detachability to allow for the separation of the top aperatured sheet from the lower substrate. It may be advantageous to remove the top aperatured layer for subjecting the plurality of sample materials deposited upon the lower substrate layer to screening/testing procedures. The samples may be covered or uncovered during various steps in the method described herein.

In a further embodiment of the present invention, an apparatus is provided wherein the plurality of materials deposited upon a substrate is mounted onto a platform and subsequently a probe, connected to a force transducer, is utilized to characterize various physical properties of the plurality of material formulations. In one embodiment, the platform, having the substrate and plurality of material formulations, is moved into an appropriate position, in order to bring the various individual material formulations under the probe for screening/testing. In another variation, the substrate with material formulations is stationary and the probe is moved into appropriate positions for screening/testing each of the plurality of material formulations disposed upon the substrate. The probe may be subjected to cleaning operations between testing steps. Furthermore, the probe(s) may be articulated and/or have raised contact/testing surfaces.

In another embodiment, the screening/testing apparatus has a plurality of probes and is able to test the plurality of materials, having various formulations and deposited upon the substrate, in parallel. In this embodiment, the platform may be automated, in order position the plurality of material formulations in appropriate positions for testing operations conducted by the apparatus. Alternatively, the platform may be movable or stationary and have a probe or plurality of probes which are positionable in order to be in appropriate alignment with the plurality of materials undergoing screening/testing. The apparatus also has coupling means for coupling the apparatus to a computer, as known in the art. The computer provides means for controlling the probe(s). Additionally, the apparatus may have automated means for displacing either the probe, the platform or both in any direction; and further has recording and analyzing means for recording and analyzing information provided by the probe(s).

Optionally, the plurality of materials having various formulations may be cured or subjected to various conditions or treatments before being placed into the sample receiving wells of the multi-receptacle assembly. Furthermore, once inside the sample receiving wells, the material formulations may be subjected to experimentally manipulated conditions. The materials may be subjected to various treatment or conditions even after having been deposited and dried/cured, for example, upon a substrate. Various treatments and/or conditions may be applied to the plurality of material formulations at any time during the screening/testing process.

In another embodiment, the plurality of material formulations may further be comprised of dye added to the formulations in order to determine the thickness of samples of the plurality of material formulations disposed upon a substrate. Such dye additions to material formulations provide for the use of photometry techniques to determine sample material thickness. Additionally, the haziness or absorbance of the material formulations is utilized to screen out compatible and incompatible combinations of components.

Further details, features and advantages provided by the teachings of the present invention will become apparent with further reference to the following detailed description, taken in conjunction with the accompanying drawings, which illustrate the principles of the invention.

### BRIEF DESCRIPTION OF THE DRAWINGS

FIG. 1 is an exemplary schematic of a test profile of a sample material formulation;

FIG. 2 is a schematic showing various exemplary steps of combinatorial approaches to material formulations and testing/ranking methodologies in accordance with the teachings of the present invention;

FIG. 3 is an exemplary method for the production of an array of materials having various formulations, deposited upon a substrate;

FIG. 4a is a perspective view of an exemplary vertical centrifuge, having a horizontal axis of rotation, usable in one embodiment of the invention;

FIG. 4b is a side view of an aperatured sheet upon a substrate, thereby forming a plurality of sample receiving wells and having a laminate construction, usable in one embodiment of the invention and is shown to be flexible and able to flex when subjugated to a force;

FIG. 5 is a schematic exemplary side view of a vertical centrifuge having an external ultraviolet light source and a centrifuge mounted mirror;

FIG. 6 is a schematic frontal view of a vertical centrifuge with mounted mirror and/or internal radiation/heat/light source;

FIG. 7 is a side view of a well plate having a removable top portion usable in one embodiment of the invention;

FIG. 8 is a side view of another well plate, having separable top and bottom portions, usable in one embodiment of the invention;

FIG. 9 is a schematic of an exemplary array of materials upon various differing substrates;

FIG. 10 is a schematic of exemplary instrumentation which may be used for array screening/testing in accordance with the teachings of the present invention;

FIG. 11 is another schematic of instrumentation having various automated features which may be utilized for screening/testing arrays of materials;

FIG. 12 is an exemplary depiction of a probe having raised surfaces;

FIG. 13 depicts an exemplary plot of results of AAT Energy, Force (1st Peak) and Peel testing;

FIG. 14 depicts an exemplary plot of AAT Displacement and Shear testing;

FIG. 15 is a graphical representation of the best 18 combinatorial hits along with 4 poor samples that are well off of the desired target characteristics as compared to target adhesive;

FIG. 16 is an exemplary graphical representation of combinatorial SPAT Energy and lab coated peel testing results;

FIG. 17 graphically depicts exemplary combinatorial Force and lab coated Peel testing results;

FIG. 18 graphically depicts exemplary combinatorial AAT Displacement with lab coated Shear testing results for various material samples; and

FIG. 19 is a three dimensional plot of First Peak, Energy and Displacement representing tack, peel and shear adhesion properties respectively.

### DETAILED DESCRIPTION OF THE PREFERRED EMBODIMENTS

While the specification describes particular embodiments of the present invention, those of ordinary skill can devise variations of the present invention without departing from the inventive concept.

The material screening/testing apparatus/devices and associated methods of the present invention are designed for use in conjunction with combinatorial approaches to the formulation and discovery of various pressure sensitive adhesive materials. Such approaches entail testing a wide and varied number of material formulations as a result of formulating, compounding, screening/testing potentially thousands of formulations per day.

The coatings of these material formulations may vary in starting components, amounts/ratios of starting components, method(s) of treating the coatings before screening/testing, the substrates upon which the formulations will be coated upon, the thickness of the tested coating as well as the conditions under which screening/testing takes place. Various coating materials, adhesives, films and other materials may be made and screened/tested utilizing the teachings of the present invention.

Automation of the steps of experimental design, formulating, compounding, coating (and optionally drying/curing), screening/testing and evaluating the materials having various formulations will increase the rate of discovery of new materials, and of various treatments and preparation/processing conditions which result in materials that have desired characteristics for desired applications.

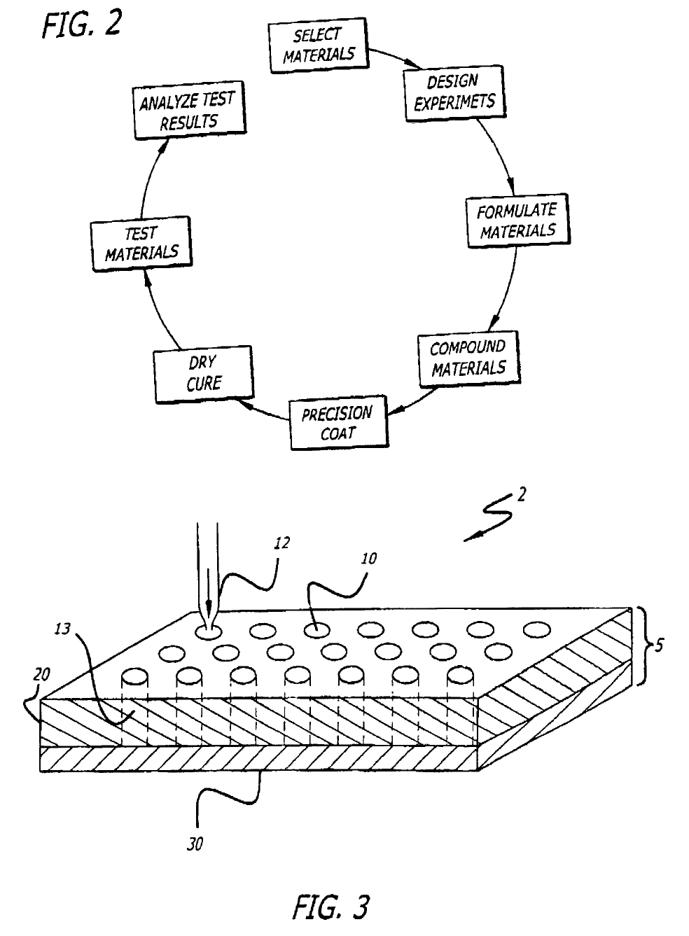

Turning to FIG. 2, a schematic of exemplary steps which may be utilized in the testing/screening methods of combinatorial methodologies is depicted for illustrative purposes. In the first step, components are selected that are to be formulated and compounded and comprise components of the materials. These components may be selected as likely candidate materials in light of previous knowledge regarding particular characteristics of the components, especially when potential applications of the final material are kept in mind. These can comprise formulations of generally dilute solutions of ingredients that are contemplated as likely elements or components. As examples, starting materials may include base polymers, tackifiers, blends of polymers, fillers, waxes, cross-linkers and/or plasticizers. Starting materials may also include solvent, water-based or bulk polymers, including acrylic, rubber-based, silicone, epoxy and urethane polymers. At this step, preliminary work of particular parameter(s) of screening/testing may also be evaluated (i.e., is the ATT probe material well suited for the correlation between combinatorial methodology testing and the desired conventional lab testing substrates).

The combinatorial screening methods of the present invention may be used to evaluate the following, exemplary non-exhaustive list of candidate formulated PSAs: base polymers (including individual polymers and blends of multiple base polymers); tackifier resins (including individual tackifier resins and blends of multiple tackifiers); base polymer-tackifier blend ratios (as discussed); cross-linkers; and other additives, such as but not limited to fillers, waxes and/or conductivity enhancers.

The invention provides users with methods to formulate various materials, including acrylic PSA (including solvent and emulsion PSAs). As known in the art, a critical threshold in selecting base polymers and tackifiers, for tackified PSAs, is the compatibility of these components. Usually, one blends candidate base polymers and tackifiers at a fixed ratio, such as a 50% load and runs “master curves” to obtain, utilizing the DMA (Dynamic Mechanical Analysis) test, results that show whether or not they are compatible. Compatibility may also be determined by utilizing the haziness of the final, mixed formulation, as detailed below. By utilizing the combination of apparatus and methods (including array formations) of the present invention, one can screen large sample sets testing not only the compatibility of tackifiers with base polymers, for example, but also screen various formulations of these components. This increase in the rate of screening various combinations and ratios of base polymers and tackifiers is desirable because compatibility, in some cases, may be dependent on the ratio of particular components. The invention provides users with a method for characterizing, at a high rate, numerous tackifier/base polymer formulations across a range of ratios.

Continuing with the PSA formulation examples, once an initial compatibility screen has been executed, another level of screening may take place. Screening continued to determine if the ATT probe material (polyethylene) was well suited for the correlation between combinatorial methodology testing and the desired conventional lab testing substrates (high density polyethylene substrates). Here, the screen would entail the deposition of the previously identified formulation of PSA onto various backing constructions. Exemplary backing constructions may include paper, vinyl, plastics, high-density polyethylene (HDPE), film and cardstock, for example. These substrates are then mounted upon platform 48 and the PSA may undergo additional screening/testing, now disposed among different substrates.

The second step for a researcher, for example, is to design experiments having particular parameter(s) of screening/testing. These parameter(s) may include, for example, the combination and/or amounts of components, or the conditions under which experimental formulations of the components will be treated, such as humidity, temperature, reaction times, carrier solvent, degree of mixing, variations of coat weights and thickness, among others. In designing experiments and screening/testing methods, a user may utilize a computer program and/or mathematical models and/or previous knowledge in order to arrive at various combinations and/or amounts of components, compounding and screening/testing conditions.

Under certain circumstances, one may want to formulate a material that matches or exceeds one or more critical properties of a pre-existing PSA (the target), for example. The target may have particular properties, for example displacement at debonding, shear strength, or adhesiveness, for example. Based upon customer (or application dependent) priorities, the PSA formulation that is the object of the screen may have various physical requirements.

The third step of the present invention, is the use of an array or arrays of samples of a plurality of material formulations, which are screened/tested by various instruments, such as a AAT, for example. As mentioned previously, these material formulations may be provided, in general, by the exemplary steps and procedures diagramed in FIG. 2. Some, all or any combinations of steps may be provided by automated methods or means. These may include automated homogenizers, dispensers and formulators for instance. An exemplary automated/robotic instrument that may be used in component formulating steps is the HP Robotic Liquid Dispenser which results in a reduction of evaporative losses typically encountered during formulation steps when utilizing carrier solvents and the like.

In the combinatorial study of various materials such as coatings, adhesives and films, for example, several different formulations are prepared from different components. Total amounts for each sample formulation are relatively small (<about 2000 microliters). Preparing these formulations accurately utilizing various components (stock solutions, having known concentrations, for example) is a difficult task. Robotic liquid dispensers are designed in order to perform this task and dispense small amount of liquids and prepare various formulations. These robotic dispensers can handle relatively low viscosity liquids with reasonable accuracy.

Even though it is difficult to dispense high viscosity liquids accurately, the actual amount or weight percentage for each ingredient can be measured very accurately. This is performed using a micro-balance and by weighing each component being dispensed. An exemplary method utilizes a digital micro-balance that is integrated with the liquid dispensing robot. Control software for liquid dispensing robot is modified in order to record the weight of the each ingredient in each formulation automatically.

The following is a typical, exemplary algorithm demonstrating a sequence of events in dispensing each component for each formulation: initializing the communication reset, close the scale's door for each well for each component tare, open the door [get tip, pipette for example], aspirate dispense [dispose tip] flush, close the door, measure and record weight, loop. Utilizing this method, it has been shown that actual measurements obtained using a robot-balance integrated system and incorporating the density of the mixture to calculate the volumes, resulted in weight measurements accurate up to about 0.1 mg that corresponds to 0.1 pL if density is 1 g/cm². This is in fact much lower than the dispensing error for the robot.

Using the present system, very accurate composition measurement are achieved and provide for efficient combinatorial study/testing/screening of a whole range of compositions having various formulations.

As used herein, a “mother” well plate is defined as a source well plate. Such plates may be comprised of Teflon, glass, polypropylene and polystyrene, for instance. For example, a 25 micron thick sample that is 1 cm² in domain size with a coating solution that is 50% solids, will require (1 cm²×25 microns/0.5) volume units or 0.0050 cc of solution. “Domain size”, as used herein, refers to the minimum area required for the formulation as determined by downstream testing. The appropriate volume of individual formulations from this mother well plate can then be dispensed to a sample or “daughter” well plate to make a coating or sample with the desired domain size for subsequent analysis and data collection.

For the fourth step as utilized herein, the term compounding means to combine, mix, or form a compound, that is, to combine or create by combining two or more components or parts.

Robotic, automated compounding or mixing of the formulations can be achieved by utilizing commercially available positioning equipment, such as Asymtek's x,y,z, coordinate motion equipment. To this is attached a mixing apparatus that drives a microblade or impeller attachment. This is typically made by cutting a piece of polyethylene tubing in fourths thereby providing four strips, for example. These strips, located at the end of the tubing are bent outward providing a microblade. The microblade is attached to the end of a micromotor and consists of mixing blades that when placed into the appropriate mixing well and spun by the mixing apparatus, mixes the components of the formulations. This microblade may be disposable or washed (in a solvent, for example) and reused in order to minimize cross-contamination. The impeller may also be disposable and discarded after every use. Preferably a well volume of 0.5 to 3 cubic centimeters is contemplated for use in the present invention. The minimum quantity or volume of component to be mixed in a “mother” wellplate will vary depending upon the desired coating thickness, domain size and formulation of the formulated sample solution. The micro-blade or impeller has provided a useful and efficient method for mixing formulations in well plates. Other forms of mixing may also be utilized in accordance with the teachings of the present invention. For example, vibration, shakers, magnetic stir bars as well as magnetic mixing spheres which are placed into the mixing wells and utilize a magnetic force to move the spheres through the mixture, thus mixing the components of the sample, may also be used to mix the various components of the various formulations.

The fifth step in the development of a material sample (an adhesive, for example) is to create the various mixed formulations that are to be placed in sample receiving receptacles 10 in the array. In one embodiment of the present invention, such sample formulations can be mixed or prepared in a multi-well plate format with each individual well containing a unique, pre-defined formulation to be tested. A variety of types of commercially available multi-well plates suitable for use in the present invention can be used (Millipore Corp., Polyfiltronics, VWR Scientific). Such multi-well plates can vary in size of plate dimension, size of well (outer circumference as well as well-depth), type of material used to construct the multi-well plate (for example, polystyrene or polypropylene, rigid plastic or flexible plastic). The biotechnology and pharmaceutical industry utilizes multi-well plates (generally 48-, 96- or 256-well plates) whose outer dimensions are standardized for use with robotic dispensers. Generally, standardized multi-well plates are rectangular, rigid, stackable plates with right edges of the top or lid portion being curved 29. The outside dimensions of a complete multi-well unit are approximately 5×3.25 inches. Such multi-well plates are suitable for use in the present invention. In general, the well size used should be of substantial volume so as to allow adequate robotic mixing of the required or needed amount of each formulation without drying up of the solutions contained in the wells. One exemplary method for accurately preparing various formulations utilizes the integration of a balance with a robotic liquid dispenser.

Daughter plates, from which arrays may be formed, may have multiple samples of a particular material formulation. One particular parameter that may be varied is coat weight/thickness of the samples. For instance, three different volumes of a particular formulation may be disposed into the sample receiving wells. For example, instead of focusing on achieving exactly a particular coat weight of a sample (very time consuming) a user may instead be interested in a range of coat weights. Therefore and in order to approximate this weight efficiently, three samples (low, medium and high volume drop), for instance, may be drawn off of the “mother” well plate and disposed into a plurality of sample receiving receptacles. This may be performed multiple times in order to provide replicated samples at different coat weights and/or thickness for testing/screening and statistical computations.

It should be understood that alternative embodiments include use of a single well plate as both the mother and daughter well plate. In such a case, the well plate into which the sample formulations are mixed will also serve as the well plate from which the materials will be tested. Again, considerations of desired coating thickness, domain size and formulation of coating solutions will be included in determination of minimum volume of well size required. Furthermore, compounding the various components, as described above, is typically carried out utilizing various carrier solvents and as such, evaporation is typically minimized by minimizing the components and the formulations to the atmosphere by generally keeping component stock solutions, as well as formulated materials covered, utilizing lids, parafilm and other methods known to those in the art.

Exemplary methods for providing an array or arrays of materials having various formulations are herein provided. FIG. 3 provides a schematic view of an exemplary multi-receptacle assembly 2 having a plurality of sample receiving wells for producing arrays of a plurality of materials, each of which may have a differing formulations or similar formulations. Additionally, the thickness of each sample may also be varied from one another. Such assemblies may comprise a two-layer assembly wherein the first layer has a plurality of apertures and the second layer is a substrate layer. Both layers can be flexible, with the second or bottom layer being detachable from the overlying first layer. Such an apparatus can be made of disposable material, thus providing a cost-effective, efficient and reliable means of providing arrays of material for the testing/screening of numerous formulations of material. A detailed description of such multi-receptacle apparatus may be found in published PCT applications WO01/33211 A1 and WO01/32320 A1, both published on May 10, 2001, both of which are herein incorporated in their entirety by reference.

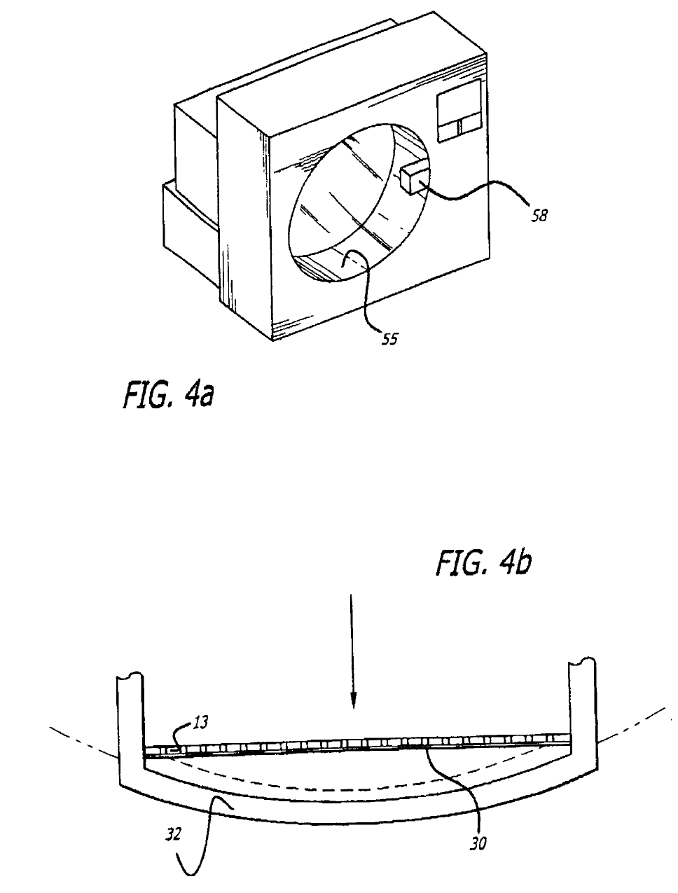

Briefly and referring to FIG. 3, multi-receptacle assembly 2 is comprised of an apertured sheet 20 sealingly placed upon a substrate 30 forming a two layer assembly 5. An exemplary depiction of a plurality of apertures 10 is shown, comprising seven rows of three, providing twenty-one individual sample receiving wells 13. Substrate 30 and/or apertured sheet 20 may be flexible and is employed to provide a plurality of sample receiving wells 13. While apertures 10 herein depicted are circular and are provided in rows/columns, apertures 10 configuration may be other shapes (triangular, square, polygon etc.) and/or arranged in various other permutations (a single row, a cross, as a square etc.) and the arrangements and numbers of apertures 10 are only exemplary. The apertured sheet may have many thousands of apertures to provide a high number of sample receiving wells 13 and thus samples for screening/testing purposes. Such a flexible, apertured sheet 20 may be constructed of materials which provide a tight, non-slip seal when apertured sheet 20 is placed upon substrate 30. When flexible material, such as silicone-rubber, is utilized for apertured sheet 20 portion of the multi-receptacle assembly 2, no adhesive is necessary to secure aperatured sheet 20 portion to the substrate 30 portion of the multi-receptacle assembly 2, although adhesive may be applied and/or required for particular testing/screening conditions or material formulations. Substrate 30 may be comprised of mylar, sheet metal, plastic materials and paper materials among others. Sample receiving wells 13, in which the material formulation samples are placed, are leak-proof in order to prevent the cross-contamination of material formulations that are placed in each of the sample receiving wells 13, by dispensing apparatus 12. Dispensing apparatus 12 may utilize pipette(s) or a nozzle, for example, which may be automated or operated manually. Once the plurality of materials, which may have a various formulations, has been placed into the various sample receiving wells 13 and have been cured and or dried, apertured sheet 20 may be removed from substrate 30, thereby providing an array of samples of the materials 15, disposed upon substrate 30 for screening/testing purposes, as shown in FIG. 7 for example. It is also contemplated that screening/testing may take place without the removal of apertured sheet 20. Each individual sample 22, now disposed upon substrate 30, may be subjected to screening/testing or, if desired, subjected to further treatments/conditions, such as thermal curing, before being screened/tested. It is further contemplated that substrate 30 surface may have depression into/upon which the plurality of material formulations may be placed. The multi-receptacle assembly 2 may have or adopt a curved configuration when mounted in a centrifuge, such as the exemplary centrifuge shown in FIG. 4a. This configuration is particularly useful for spin casting material formulations, as will be discussed in more detail below. As such multi-receptacle assembly 2 is also referred to as a multi-layered casting assembly.

There are many methods by which material formulations may be provided in an array format and disposed upon substrate 30 for screening/testing purposes. Available methods include spin coating, dip coating, sputtering, brushing as well as spin-casting, blade or knife coating, ink jet-type coating and droplet or drop-ink coating, as detailed above and incorporated PCT applications WO01/33211 A1 and WO01/32320 A1, which is incorporated by reference herein. As detailed in these patent applications, materials having various formulations may be flattened in sample receiving wells 13 by use of a leveling force. A “leveling force” as used herein, is defined as any force sufficient to cause a sample of material to distribute evenly and flatly onto substrate 30. A leveling force will also remove any residual air bubbles present within array and minimize and even eliminate meniscus formation within the sample(s). This type of coating procedure is referred to as “spin casting”, that is, the samples will be cast into the shape of the internal portion of sample receiving well 13, for example, here, a thin cylinder. A variety of leveling forces are contemplated for use in the present invention including, for example, use of centrifugal force, a vacuum or negative pressure force, an electrostatic force, or a magnetic force. In the case where magnetic leveling force is used, the material formulations tested/screened will contain magnetic particles, powder, or a compound such as ferrite, that is responsive to a magnetic force. Use of a leveling force need not be limited to single-material assessments. Where the processing of a multi-layer construction of sample material is desired, a leveling force can be repeatedly applied following dispensing of individual layers of a formulation to be tested. The final array obtained will be a planar sheet containing discrete areas in a grid format of multi-layer material formulations.

Returning to FIG. 4a, a perspective view of an exemplary vertical centrifuge having a horizontal axis of rotation usable in one embodiment of the invention is shown. This “rotating-drum” type of centrifuge has an inner surface 55 upon which multi-receptacle assembly 2 may be mounted, and covered if desired. Exemplary coverings include filter paper or other sheet material, for example. The centrifuge may have a sealed internal atmosphere wherein various curing or drying conditions may be specified, such as temperature and humidity as well as gaseous content (i.e., nitrogen). Once the centrifuge is activated, multi-receptacle assembly 2 having a plurality of sample formulations therein, is spun. Other conventional centrifuges, having swing arms for example, may also be used.

FIG. 4b is a side view of multi-receptacle assembly 2, which forms a plurality of sample receiving wells 13 and having a laminate construction, usable in one embodiment of the invention. Here multi-receptacle assembly 2 is shown to be flexible and able to flex when subjugated to a force; for example a centrifugal force that is normal to the surface of substrate 30 and represented as an arrow in FIG. 4b. The walls of a centrifuge 32 upon which multi-receptacle assembly 2 is mounted, provide support once the centrifuge is activated and flexible multi-receptacle assembly 2 flexes outward and adopts the curvature of wall 32, as represented here by dashed lines.

Once the selected components have been formulated and compounded, in order to provide an array of materials of various formulations, the material may be deposited upon a substrate for screening/testing purposes and/or be subjected to various conditions. While samples of material formulations are typically disposed upon a substrate or substrates to be tested/screened and/or cured and/or dried, it is contemplated that the materials may screened/tested in the very vessels in which the compounding has taken place.

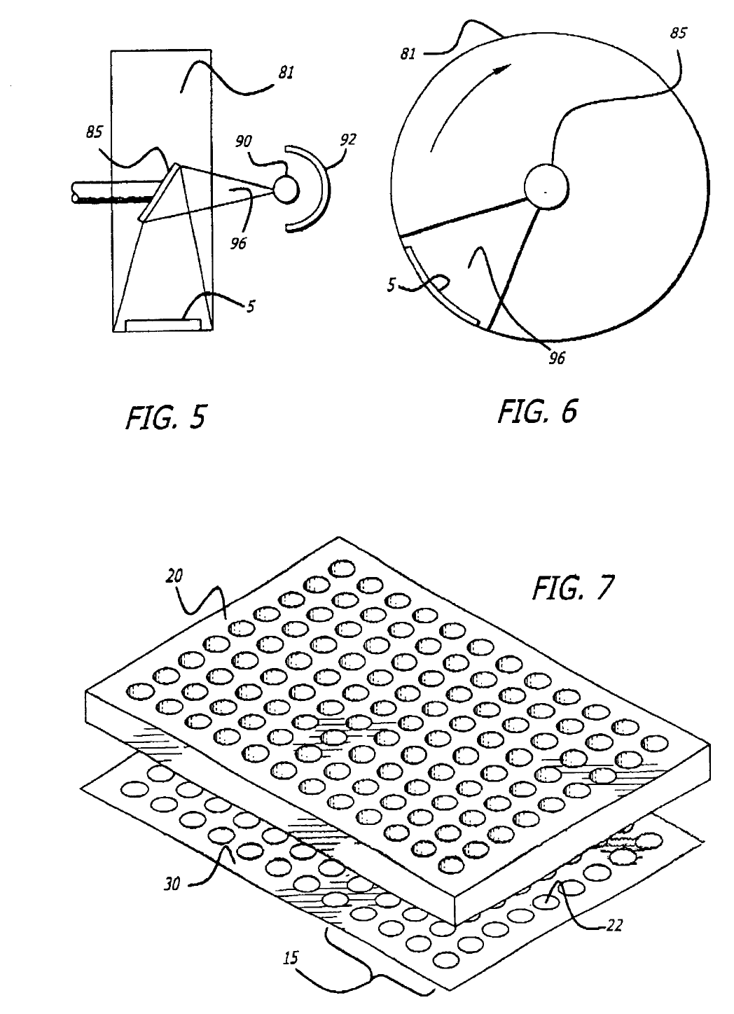

For the sixth step the plurality of formulations in the plurality of sample receiving wells 13 in multi-receptacle assembly 2, may be subjected to various drying/curing steps while under centrifugal force. These may include thermal curing to drive off various volatile or solvent components, radiation (ionizing and/or non-ionizing) curing (UV, electron beam curing). Arrays may also be exposed to variations in curing temperatures (cold and/or hot). This may be illustrated and accomplished by exposing the samples to ultraviolet (UV) radiation, filament heaters, ovens, as well as other methods. In the exemplary embodiment, shown in FIGS. 4a, 5, 6, a UV source is shown. A UV “crawler” 58 is mounted inside the drum wall portion 55 of the vertical centrifuge. This device emits a UV beam as wide as the multi-receptacle assembly 2 array mounted on the inner rotating drum wall 55 of the vertical centrifuge. In this example, the samples in multi-receptacle assembly 2 are intermittently exposed to the UV beam on each rotation while the “crawler” 58 is mounted at a position along the circumference of the centrifuge. One is able to vary the position of the UV emitting portion of the “crawler” 58 so as to change the distance between the emission source positions and the multi-receptacle assembly 2 thereby changing the intensity of the UV radiation exposure that the samples undergo during centrifugation. This variation may be used to alter curing parameters (such as drying and/or curing time). Furthermore, more than one crawler may be mounted along the circumference of the centrifuge and emission may be switched on and off depending on the desired protocol. It is also contemplated, as shown in FIGS. 5 and 6 (side and frontal views, respectively) that a mirror 85 may be placed inside the drum 81 of the vertical centrifuge and the UV source 90 located externally along with a reflector 92. If mirror 85 is stationary, multi-receptacle assembly 2 with sample formulations in receiving wells 13 will be exposed to the reflected UV beam 96 intermittently during rotation. The mirror may also be configured so as to rotate with the drum, to direct UV beams at a stationary location on the drum wall where sample formulations in receiving wells 13 would be placed and receive continuous UV exposure. As those skilled in the art will appreciate, these mounting configurations may be adapted to mount other sources of radiation, such as microwave, infrared, filament heaters as well as others, either within the centrifuge or externally. This setup, combined with the fact that the formulation's casted shape variations are minimized during centrifugation, provides a more uniform sample array for screening/testing new material formulations.

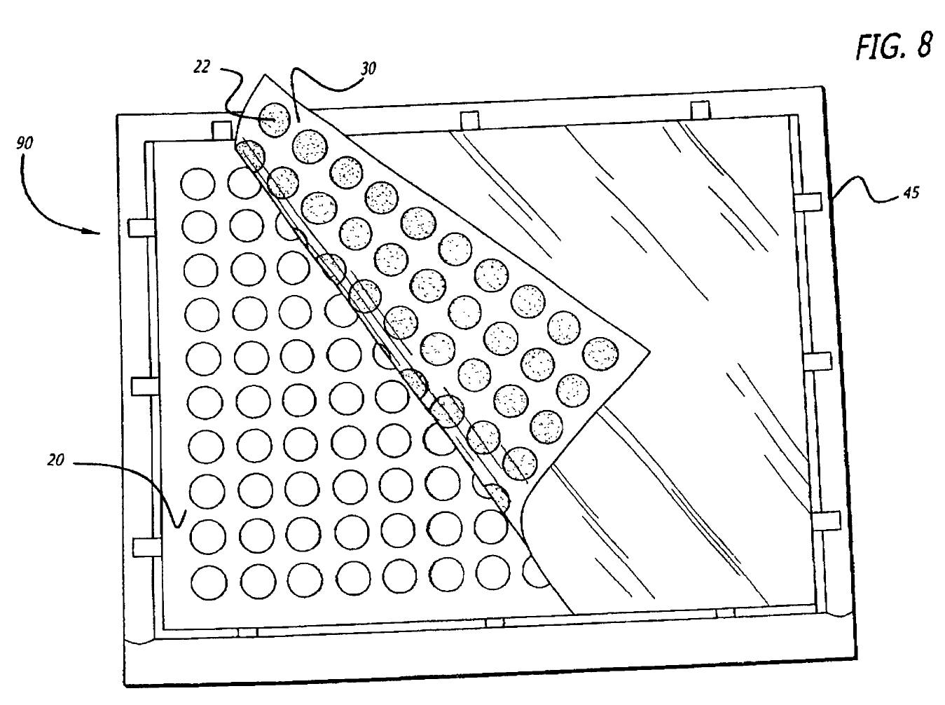

Once the centrifuging and/or drying and/or curing of the plurality of materials, which may have differing formulations, is completed, multi-receptacle assembly 2 is removed and apertured sheet 20 can be removed from substrate 30, as depicted in FIGS. 7 and 8. After the drying and/or curing step, multi-receptacle assembly 2 may be placed into a cooled chamber to cool down the assembly 2, and then remove apertured sheet 20. As can be seen in both figures, this results in an array 15 of materials disposed upon substrate 30, each sample 22 neatly formed. FIG. 8 particularly depicts another embodiment of a multi-receptacle assembly 90 which may be used by the invention, this one providing an oversized frame 45 having an apertured portion, onto which substrate 30 may be placed. This multi-receptacle assembly 2 also provides separability of substrate 30 from overlying frame 45 and a plurality of sample 22 materials for testing/screening.

For the seventh step once an array 15 of materials has been formed, the testing/screening may commence. As stated previously, any type of testing/screening may be performed on the array 15. These include any test that may measure various properties of the materials in array 15. These include testing/screening for adhesive or cohesive properties of the materials. Tack tests methods utilizing various probes may be used for screening/testing, including the AAT test. Additionally, gel tests, for determining cross-linking and hence cohesive strength, may be utilized, as well as Differential Scanning Calorimetry to measure the glass transition of the material samples in the array. Further tests which may be utilized include flow testing (displacement under pressure) the samples in the array 15.

The AAT test, as discussed previously and in the articles referenced herein, is ideal for testing small samples of materials. As described herein, the array of sample material may contain thousands of samples of materials having various formulations. The use of the AAT test with the arrays described, provides an expeditious and efficient manner for the screening/testing of various material formulations and resultant materials.

The probe tester is utilized in order to measure the various properties of materials. An exemplary probe tester is the AAT and is able to measure a variety of properties. These properties include cohesiveness, adhesiveness, hardness, stickiness or tackiness, resilience, elasticity, creep, stiffness, yield, stiffness and fracturability. The testing of small samples is ideally suited to the AAT test in particular, and is able to provide information regarding the adhesive and cohesive properties of a small screen/test sample. The results provided by AAT testing/screening of an array 15 of sample materials, provided by the methods described herein, correlates well with the more standard tests such as peel testing and shear testing. These standard tests require much larger samples and much longer test periods. The use of arrays and AAT testing has been shown to, in one day of testing/screening, provide an equivalent amount testing/screening information that normally requires three days of testing/screening utilizing prior methods. Other exemplary test/screening methods include atomic force microscopy, permeability testing, dielectric constant testing, refractive index testing, hardness testing, and modulus testing, for example.

One area of material research to which the teachings of the present invention may be applied is to the formulation of pressure sensitive adhesives (PSA), including permanent PSAs, removable PSAs, solvent based PSAs, acrylic PSAs, acrylic copolymer (styrene, vinyl acetate, vinyl pyrrolidone) PSAs, and the like. For example, by utilizing the teachings of the present invention, a manufacturer may more quickly screen/test and develop customized material formulations in accordance with a customer's requirements.

Firstly, an array of materials is formed, as previously described. It is desirable for these test samples to be provided at controlled coat weights, ideally at or very close to a nominal coat weight. In the case of PSAs, the thickness of the coating of samples onto substrate 30 can be from about 1 to about 5 mil. Variations in the solids content of the PSAs may lead to variations in coat weights form the target values.

One particular method that may be utilized to determine the thickness of samples in an array utilizes Beer's law. In this high throughput method for measuring thickness of small coatings of sample material (pressure sensitive adhesives of various formulations, for example) spectrophotometry is utilized to determine coating or sample 22 thickness upon a substrate.

Beer's law is the basis for quantitative spectrophotometry, the most commonly used chemical analysis method. It is expressed by the following formula: A=abc where A=the absorbance at a wavelength of light at which the sample absorbs, a=the extinction coefficient, a constant characteristic of the absorbing substance, b=the path length through which the light travels, c=the concentration of the absorbing substance. Utilizing Beer's law, the following paragraph details an exemplary demonstration of this spectrophotometric method of determining the thickness of a sample, which is utilized for multiple samples in an array format.

Knowing the extinction coefficient and concentration of an additive (dye, for example), and by measuring the aborbance of a sample 22, we can calculate the path length (i.e. thickness) of sample 22. To implement this method a dye is added in low but accurately known concentration to the sample mixtures. After coating the samples onto a substrate, for example, the absorbance at the appropriate wavelength is measured and the coatweight is calculated using Beer's law. An exemplary dye that has performed very well is methyl red whose extinction coefficient at 482 nm was measured by making a solution of the dye of known concentration in toluene and measuring its absorbance at 482 nm on a standard UV-Vis spectrophotometer. Other dyes may also be utilized in order to determine the coatweight/thickness of a sample 22. An exemplary solvent adhesive formulation was disposed onto a substrate thus providing several samples in an array format. The thickness at several locations was measured using a commercial instrument (PosiTector 6000) that uses a magnetic eddy current principle to gauge thickness. A BioTek MicroQuant UV-Vis plate reader was used to measure absorbances at 482 nm at the same locations. The plate reader measures up to 96 coatings in 30 seconds and provides an efficient method for determining the thickness of a plurality of samples disposed upon a substrate. This methodology has already been implemented for a series of adhesive formulations and has provided for the rapid measurement of thickness of a large number of coatings.

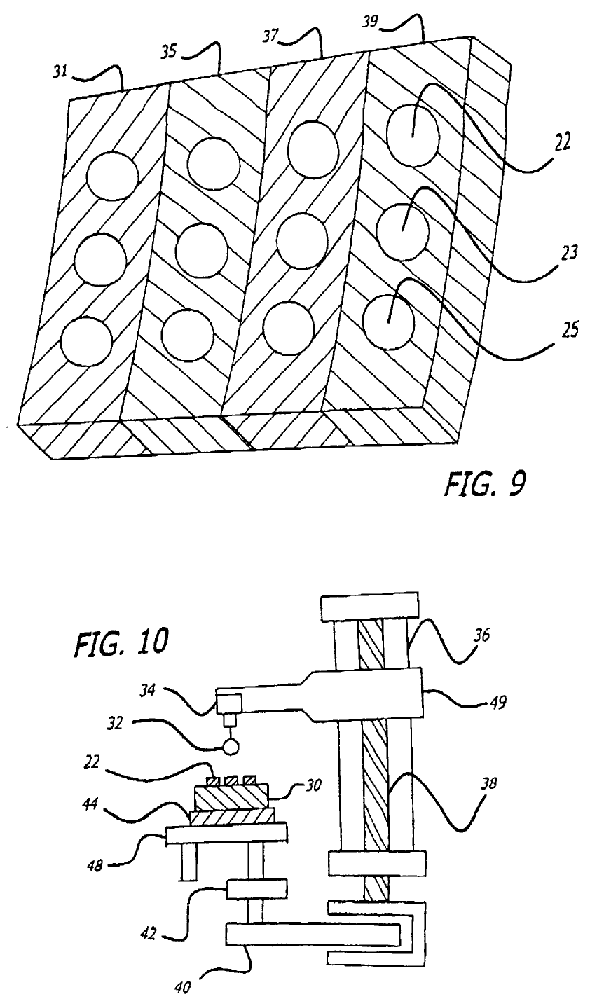

An alternative example of an array which may be utilized in the invention is shown in FIG. 9. FIG. 9 depicts an example of an array wherein a plurality of samples, for example 22, 23, 24, are disposed upon a substrate 39. Here, exemplary substrates 31, 35, 37, and 39, upon which sample materials are disposed, may be comprised of different materials. Additionally, it is contemplated that material samples 22, 23, 24 may vary from one another in formulation or coating thickness. This naturally applies to the other samples of material in the array, having the same or different substrates 31, 35, 37, and 39.

Once the array of material is disposed upon substrate 30 for example, the array is mounted onto the screening/testing apparatus. FIG. 10 shows an exemplary configuration of instrumentation that may be utilized in accordance with the teachings of the present invention. Here, a AAT screening/testing configuration is utilized in conjunction with the array of sample materials.

Firstly, substrate 30 having samples of materials 22 thereon disposed in an array format, is mounted to platform 48. Mounting may be accomplished by any standard method. For example, substrate 30 may be held in place by a layer of adhesive 44 disposed (exaggerated dimensions) between platform 48 and substrate 30. Adhesive 44 may be comprised of double sided tape for example. The apparatus of FIG. 10 has a probe 32 connected to a force transducer 34. Probe 32 is displaced by the activation of a stepping motor 42 connected to belt 40 which moves arm 49 having guides 36 utilizing screw 38. The displacement, recording of test results and computations may be controlled by a computer.

Platform 48 may be an automated X-Y or X-Y-Z table in order to cycle through and position samples 22 under probe 32 for testing. Platform 48 and/or probe 32 may utilize various methods regarding the automation of these components. Various motors, solenoids, piezoelectronics and other automation means may be used to automate platform 48, probe 32 or both. Multiple areas within a sample may be tested in order to obtain consistent and reliable readings for a particular sample (dithering). It is important for substrate 30 to be flat and that Z-motion of platform 48 be adjusted in light of variations in sample 22 placement and thickness, so that platform 48 would be moved to a reference position during each test before probe 32 completes its movement. An additional effect which requires compensation is backlash error.

It is possible that probe 32 may require cleaning between tests of the samples in the array. One cleaning method may utilize a solvent in combination with a cleaning instrument. The cleaning instrument may have a rotating head, as exemplified in various shoe polishing devices. Also, cleaning of probe 32 may also entail blasting probe 32 with CO₂ followed by solvent cleaning.

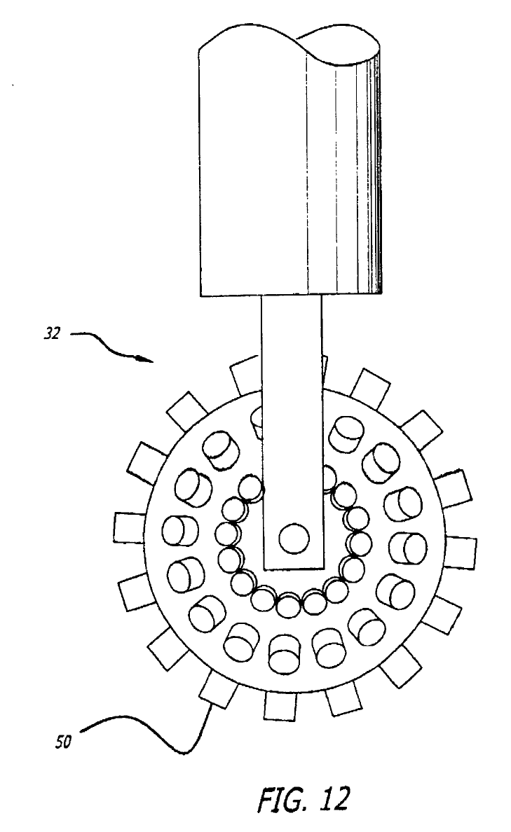

In one embodiment, probe 32 may be provided with articulation means, as exemplified by the IBM-type typewriter balls having raised portions (letters/symbols) and utilized in various typewriters and printers. Here the probe, due to its ability to rotate in various directions, may present a portion of its surface that has not come in contact with previous sample material undergoing testing/screening. The surface of probe may be smooth or may have raised portions/protrusions 50. In FIG. 12, an exemplary probe 32 is shown, having a plurality of raised portions/protrusions 50 over its surface. The probe would rotate to another “clean” protrusion 50 after each test measurement, thus not requiring a user to clean the surface of probe 32 between each test of plurality of materials in the array.

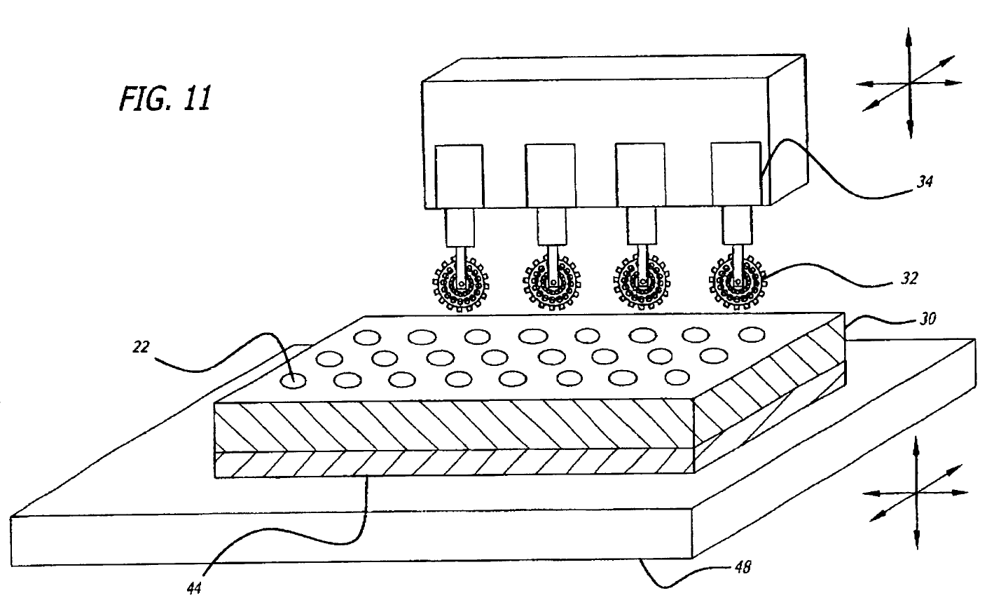

FIG. 11 exemplifies another embodiment of a screening/testing apparatus that may be used in conjunction with the teachings of the present invention. Here, as in the previously described AAT method, substrate 30 is mounted utilizing by adhesive 44 onto platform 48, which may be automated and be displaceable in the X-Y-Z direction. The apparatus has multiple probes 70 in communication with multiple force transducers 72. Arm 48 may be automated and displaceable in the X-Y-Z direction as well, in order to displace multiple probes 70 in proper alignment with samples disposed upon substrate 30. Likewise, platform 48 may be displaced in order to bring into proper alignment the array of samples with multiple probes 72. Multiple probes 72 may have similar features as described for single probe 32 (articulated, raised surfaces, etc) and may be subjected to similar cleaning regimens described previously. This particular embodiment provides for the multiple screening/testing of a plurality of sample materials in parallel. Computer recording and analyzing means, similar to those previously described and utilized in the AAT and known in the art, may be modified for recording data provided by multiple probes 74 simultaneously.

Test measurements provided by the AAT testing of the plurality of materials on substrate 30 may be provided in the form of ASCII files or Excel tables, for example. Exemplary test measurements described in the “Avery Adhesive Test Yield More Performance Data than Traditional Probe” article are not the sole measurements that may be provided. As well as the properties previously mentioned, new macros may be written that provide new methods for the analysis of data gathered by a texture analyzer. Additionally, pattern matching/recognition techniques may be employed based upon the evaluation of particular test curves that are associated with particular properties of the sample materials (such as adhesivesness or cohesiveness for example).

For the eighth step, SpotFire analysis, as well as other ranking/evaluating applications, may be used in order to rank and more easily manage data provided by the various screening/testing of the plurality of materials. The Spotfire analysis software is available from Spotfire of Somerville, Mass. We imported all data generated above steps into the SPOTFIRE Visualization program. We now had compatible formualtions with respective thickness and their adhesive properties described. We also generated similar data for known target material. We henceforth could compare the adhesive performance of targets with our candidate compositions and select promising materials for further consideration. It is noted that the energy, first peak and displacement data with respect to sample thickness may be fit to linear regression curves. Using the linear regression curves, energy, first peak and displacement may be calculated for one or more target thicknesses. The calculations may be plotted in three dimensions, for example. Data from competing compounds may also be plotted, to aid in selecting the best adhesive.

### Conventional Laboratory Methods

Preparation of Lab Coated Samples:

After polymerization, the resulting formulated polymer solution can be used to prepare an adhesive laminate or construction using fabrication techniques well know in the art. Thus, the polymer solution was coated (by “bull nose”, a type of knife coating) onto a release liner (such as a siliconized paper or film), oven dried for 15 minutes at 70° C., and then laminated to a flexible backing or facestock, i.e., vinyl film or polyethylene terephthalate (Mylar) film. The adhesive coating is applied at a desirable coat weight (conveniently measured on a dried basis), which is 25 to 35 g/m².

Adhesive Testing of Lab Coated Samples:

1. Peel Adhesion

The resulting construction is die-cut into 25×204 mm (1×8 in) sized strips. The strips were then applied centered along the lengthwise direction to 50×152 mm (2×6 in) test panels and rolled down using a 2 kg (4.5 lb.), 5.45 pli 65 shore “A” rubber-faced roller, rolling back and forth once, at a rate of 30 cm/min (12 in/min). The samples were conditioned for either 15 min, or 24 hours in a controlled environment testing room maintained at 21° C. (70° F.) and 50% relative humidity. After conditioning, the test strips were peeled away from the test panel in an Instron Universal Tester according to a modified version of the standard tape method Pressure-Sensitive Tape Council, PSTC-1 (rev. 1992), Peel Adhesion for Single Coated Tapes 180° Angle, where the peel angle was either 180° or 90°, i.e., perpendicular to the surface of the panel, at a rate of 30 cm/min (12 in/min). The force to remove the adhesive test strip for the test panel was measured in lbs./in. Stainless steel, high density polyethylene, and painted steel panels were used as test panels to measure peel adhesion. All tests were conducted in triplicate.

2. Room Temperature Shear (RTS)

In static shear testing, the samples were cut into 12×51 mm (½×2 in) test strips. The test strips were applied to brightly annealed, highly polished stainless steel teat panels, where the typical size of the test panels was 50×75 mm (2×3 in), making a sample overlap of 12×12 mm (½×12 in) with the test panel. The sample portion on the test panel was rolled down using a 2 kg (4.5 lb.), 5.45 pli 65 shore “A” rubber-faced roller, rolling back and forth once, at a rate of 30 cm/min (12 in/min). After a dwell time of at least 15 minutes under standard laboratory testing conditions, the test panels with the test strips on them were then placed at an angle 2 degrees from the vertical, and a load of 500 g was attached to the end of the test strips. A timer measured the time in minutes for the sample to fail cohesively. In the tables, the plus sign after the shear values indicate that the samples were removed after that time and that the test was discontinued. All tests were conducted in triplicate.

3. Failure Modes

The following adhesive failure modes were observed for some samples:

“panel failure” (p)—the adhesive construction detached from the test panel cleanly, without leaving a residue.

“panel stain” (ps)—the adhesive construction detached from the test panel cleanly, but left a faint stain or “shadow” on the test panel.

“heavy panel stain” (hps)—the adhesive construction left a markedly noticeable stain on the test panel.

“cohesive failure” (c)—the adhesive construction split apart, leaving adhesive residue on the test panel and the facestock.

“facestock failure” (fs)—the adhesive completely detached from the facestock, and transferred to the test panel.

“zippy” (z)—the adhesive construction detached from the panel with a slip-stick, jerky release.

“mixed” (m)—mixed failure modes.

4. Avery Adhesion Tester (AAT)

AAT measurements were made using the procedure described in Adhesives Age, vol. 10, no. 10 (September 1997), pages 18-23, which is incorporated by reference herein. The Avery Adhesion Tester consisted of a single spherical probe connected to a force transducer, where the transducer measures the force acting on the probe. A rotating screw driven by a stepping motor moves up and down the probe. The displacement of the probe is measure through the motor rotation. A PSA sample is bonded adhesive side up to the test platform using a double-sided tape. During the test, a computer records the displacement and the load on the probe. The AAT measurement involves two processes: bonding and debonding. During the bonding process, the probe moves down and compresses the adhesive to a pre-determined force (compression force). In response, the adhesive deforms and wets the probe surface. The probe can “dwell” on the adhesive surface with a constant compression force for a specified time span to enhance wetting of the adhesive onto the probe. During the debonding process, the probe ascends and separates from the adhesive surface at a pre-determined test speed. Because the adhesive is bonded to the probe surface, the adhesive is elongated and exerts a tensile force on the transducer as the probe moves up. The magnitude of this force depends on the viscoelastic properties and cavitation behavior of the adhesive. As the adhesive is further elongated, the stress in the adhesive increases until it reaches the interfacial strength between the probe and the adhesive. At this point, the adhesive begins to separate from the probe surface. The debonding strength of the adhesive is measured by the magnitude of the force and its duration time on the prove.

Test Conditions used in this study were:

| | |
|---|---|
| Probe | 25.4 mm diameter spherical probe |
| Compression force | 4.5 Newton (N) |
| Test speed | 0.04 mm/sec |
| Dwell time | 0 sec |

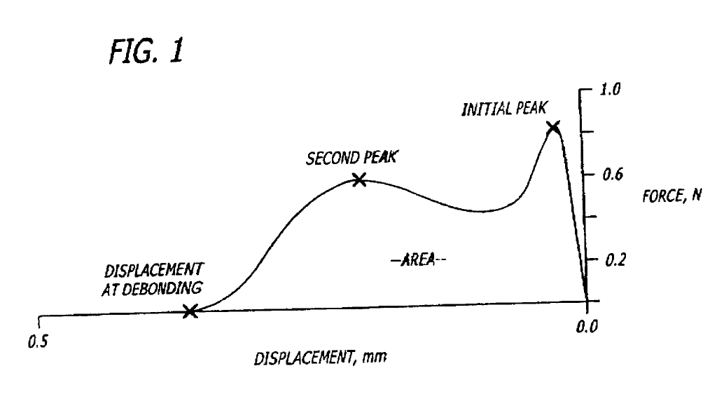

Results: A measured AAT profile is shown in FIG. 1. There are four characteristic parameters that can be identified from the AAT profiles of the adhesives. They are:

1. The height of the first or initial peak in the force versus displacement profile, measured in Newtons (N). The height of the initial peak is related to the tack performance of the adhesive.

2. The height of the second peak or shoulder in the force versus displacement profile, measured in Newtons (N). The height of the second peak is proportional to the degree of crosslinking.

3. The area under the force versus displacement profile (energy) measured in N.m. The area under the profile represents the energy required to separate the adhesive from the probe. It relates to both peel and tack.

4. The displacement at debonding in the force versus displacement profile measured in mm. The displacement measures the distance that the adhesive can be elongated before it detaches from the probe. The displacement is inversely related to the adhesive shear performance.

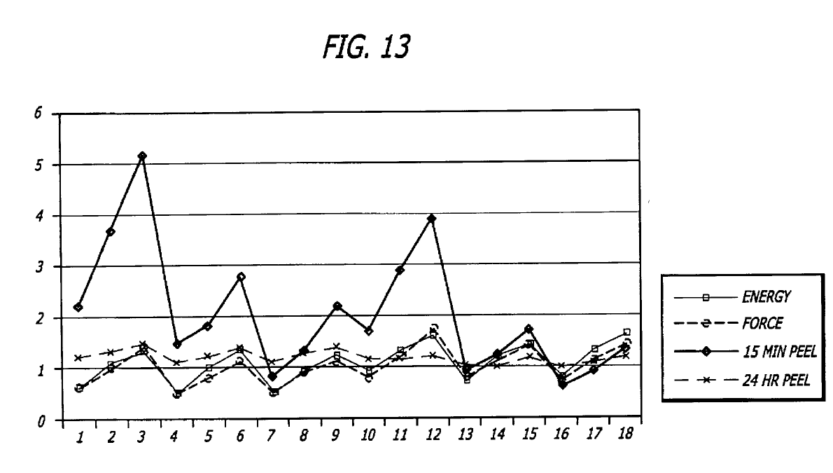

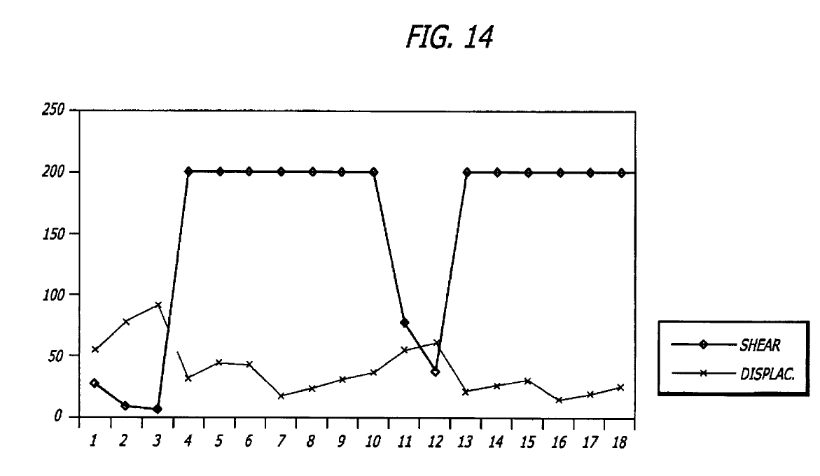

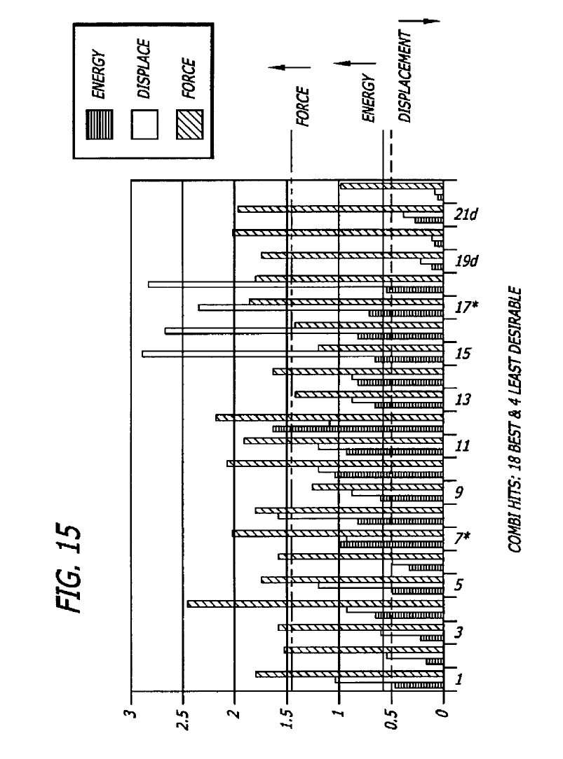

The following is a non-limiting example utilizing combinatorial methodology according to the teachings of the present invention and in reference to tables and FIGS. 13-25. This example utilizes the combinatorial methods disclosed herein (select starting components, design formulations, dispense starting components, mix starting components, process coatings, treat coatings, test materials, analyze test results) to identify compatible candidate components that can be compounded to provide adhesives having desired characteristics: good adhesion to low surface energy substrates (peel adhesion off high density polyethylene test panels) and good cohesion (shear resistance). The promising combinatorial formulations were compounded and coated and tested by conventional laboratory methods to validate the combinatorial methodology.

In summary: work on lab coated and tested samples showed good correlation between AAT testing and peel & shear testing, but the combi-coated samples provided less correlation between combi AAT testing and lab coated peel & shear. However identification of candidates that were worth further investigation was achieved, which is exactly what the combinatorial methodology herein disclosed provides.

### Selecting Starting Components, Designing Experiments, Dispensing, Mixing, Coating, Testing Materials and Analyzing Test Results

1. Selection of Starting Components

As a first step and as detailed previously, starting components were selected that would be utilized to formulate various pressure sensitive adhesives to be tested/screened. In this example and referring to Table I, 6 polymers were selected based on composition and Tg. For each polymer, 2 or 3 compatible tackifying resins were expertly recommended. Table I shows the starting components consisting of polymers, selected tackifiers.

TABLE I
Initial Starting Materials For The Combinatorial Study

| Polymer | Composition | Tg | Tackifing Resin Compatible with Polymer (Hercules Inc.) | | | |
|---|---|---|---|---|---|---|
| A | IOA/AA 93/7 | −39 | Foral AX | Foral 85 | Hercotac | Piccotex |
| | | | | | 2010 | 75 |
| B | EHA/AA 93/7 | −51 | Foral AX | Foral 85 | Hercotac | |
| | | | | | 2010 | |
| C | EHA/Vac/AA/GMA | −24 | Foral AX | Foral 85 | Kristalex | Piccotex |
| | 67.9/27/5/0.14 | | | | 3070 | 75 |
| D | EHA/VP/AA | −26 | Foral 85 | SB ester | Piccotex | |
| | 78/20/2 | | | 10 | 75 | |
| E | IOA/IBOA/AA | −14 | Foral AX | Foral 85 | SB ester | Hercotac |
| | 70/28/2 | | | | 10 | 2010 |
| F | EHA/BA/Vac/AA | −49 | Foral AX | Foral 85 | Hercotac | |
| | 78/14/4/4 | | | | 2010 | |

IOA = Isooctyl Acrylate, AA = Acrylic Acid, EHA = 2-Ethylhexyl Acrylate, Vac = Vinyl Acetate, GMA = Glycidyl Methacrylate, VP = Vinyl Pyrrolidone, IBOA = Isobornyl Acrylate, BA = Butyl Acrylate

Another method by which the compatibility of a tackifyer and base polymer may be assessed is based upon the haziness of sample, that is, the haziness of the compound once a particular tackifyer/polymer combination has been mixed. Typically, compatible combinations of tackyfiers and polymers result in relatively clear compounds, while incompatible combinations produce relatively hazy samples. From another perspective, the resultant compounds that are opaque or that, for example, exhibit high absorbence may not warrant further investigation while relatively clear compounds (low absorbance) may be further investigated. When test samples are provided in an array format, such arrays may be screened for particular absorbance parameters by commercially available plate spectrophotometers such as BioTek's MicroQuant UV/Vis plate reader, for example, which can measure absorbances of up to 96 samples in about 30 seconds and quickly identify compatible combinations of components, here tackifiers and base polymers, for example.

This efficient method of determining compatibility at a high throughput level, provides users with the ability to do just more that state that, for example, A is compatible or incompatible with B. Now finer and more resolute statements regarding compatibility may be made, that is, instead of just “A is compatible or incompatible with B” one may determine that “A is compatible or incompatible with B” beyond or under a certain concentration/ratio, for example. As detailed above, the spectrophotmetric techniques (absorbance measurements) described for measuring a sample's thickness/coatweight may also be utilized as a test of compatibility of various components of a material. As previously discussed, high absorbance (hazy) is typically a sign of the incompatibility of particular components at particular ratios/concentrations, for example.

As known in the art and depending on certain desired performance characteristics, the selection of base polymers is very important. Certain polymer parameters are typically taken into consideration, including exemplary monomer composition for example, molecular weight of the polymer and/or certain functionalities (polar or acid groups for example). Additionally, different polymers may be blended together in order to achieve certain performance characteristics.

Armed with this information, additional preliminary work was conducted. Two DOE's (Design of Experiments) were run with two polymers formulated with Foral 85 tackifying resin and AAA crosslinker to compare lab coated AAT testing with Peel & Shear testing. FIG. 13 shows AAT Energy and Force (1st Peak), and Peel testing. There are 18 examples, 9 for each polymer, and 3 levels of aluminum acetylaetonate (AAA) crosslinker with 3 levels of Foral 85 tackifying resin within each set, as detailed in Tables II and III, which show results for two different polymers (A and D). There is a good correlation with AAT Energy & Force and Peel testing and also AAT Energy & Peel are more sensitive to polymer variation in composition. FIG. 14 shows AAT displacement and shear testing. Shear is expected to be high when the displacement is low. There is not a good correlation in FIG. 14 because much of the shear testing lasted longer than 200 hours test without dropping. That is, many of the formulations resulted in adhesives that held particular loads longer than the allotted time period. The displacement provides much more information about the cohesive strength of the adhesives (1-18, the best candidates). The test data for this study is in Tables II and III, and is conducted on samples disposed upon various substrates. In Tables II and III, the substrate is white vinyl film, the peel test panes are stainless steel (SS), high-density polyethylene (HDPE), automotive painted panel, and recycled cardboard (RC). For the AAT testing, the probes were stainless steel, HDPE and a stainless steel probe tipped with recycled cardboard.

The cardboard probe was made by first die-cutting a cardboard paper and a transfer adhesive tape into circular pieces of ¼ inch in diameter. The cut cardboard paper was laminated to the tip of a 1-inch diameter stainless steel ball with the cut transfer tape. The cardboard paper mounted stainless steel ball was pressed against a female hemisphere cavity of 1.008 inch in diameter to ensure that the cardboard paper firmly adhered to the steel and the testing surfaces were uniform in radius of curvature.

TABLE II
Pre-Combi Preliminary Work DOE: Polymer A (IOA/AA* 93/7), AAA, Foral 85 *IOA = Isooctyl Acrylate, AA = Acrylic Acid

| | Example | | | | | | | | |
|---|---|---|---|---|---|---|---|---|---|
| | #1 | #2 | #3 | #4 | #5 | #6 | #7 | #8 | #9 |
| | Polymer | | | | | | | | |
| | Polymer | Polymer | Polymer | Polymer | Polymer | Polymer | Polymer | Polymer | Polymer |
| | A | A | A | A | A | A | A | A | A |
| % AAA | 0.15% | 0.15% | 0.15% | 0.33% | 0.33% | 0.33% | 0.50% | 0.50% | 0.50% |
| % Foral 85 | 0% | 12.5% | 25% | 0% | 12.5% | 25% | 0% | 12.5% | 25% |
| Ct. Wt. g/m² | 33.6 | 33.7 | 33.8 | 32.4 | 32.7 | 34.8 | 31.6 | 34.8 | 35.0 |

Facestock: XL1001 white vinyl

| | | | | | | | | | |
|---|---|---|---|---|---|---|---|---|---|
| Shear 500 g, | 1550sp | 480sp | 305 | 12800+ | 12800+ | 12800+ | 12800+ | 11200+ | 11200+ |
| ½″ x ½″, RT, min. | | | | | | | | | |
| Peel 180° off SS | | | | | | | | | |
| 15 min., lb/in | 3.1 | 3.5 | 4.1 | 2.8 | 3.2 | 3.4 | 2.3 | 2.7 | 3.2 |
| 24 hr., lb/in | 3.4 | 3.8 | 4.5 | 3.1 | 3.3 | 3.7 | 2.6 | 2.9 | 3.4 |
| Peel 180° off HDPE | | | | | | | | | |
| 15 min., lb/in | 0.6 | 1.0 | 1.4 | 0.5 | 0.8 | 1.1 | 0.5 | 0.9 | 1.1 |
| 24 hr., lb/in | 0.6 | 1.1 | 1.3 | 0.5 | 1.0 | 1.3 | 0.5 | 0.9 | 1.2 |

Peel 180° off Automotive Panel

| | | | | | | | | | |
|---|---|---|---|---|---|---|---|---|---|
| DuPont GEN V | | | | | | | | | |
| 15 min., lb/in | 2.5 | 2.6 | 3.3 | 2.1 | 2.3 | 2.7 | 2.0 | 2.2 | 2.5 |
| 24 hr, lb/in | 3.3 | 3.5 | 4.2 | 2.9 | 3.2 | 3.7 | 2.5 | 2.7 | 3.3 |

Peel 90° off Recycled Cardboard

| | | | | | | | | | |
|---|---|---|---|---|---|---|---|---|---|
| 15 min, lb/in (all fiber | 1.3 | 1.4 | 1.4 | 1.3 | 1.2 | 1.1 | 1.3 | 1.2 | 1.2 |
| tear) | | | | | | | | | |

Spat Test with SS Probe

| | | | | | | | | | |
|---|---|---|---|---|---|---|---|---|---|
| Force, N | 2.451 | 2.403 | 2.757 | 2.478 | 2.542 | 2.446 | 2.344 | 2.427 | 2.629 |
| Energy, Nm x e-5 | 38.1 | 39.1 | 50.9 | 26.5 | 26.3 | 35.8 | 17.2 | 19.8 | 30.7 |
| Displacement, mm | 0.452 | 0.496 | 0.546 | 0.265 | 0.281 | 0.337 | 0.190 | 0.208 | 0.282 |

Spat Test with HDPE Probe

| | | | | | | | | | |
|---|---|---|---|---|---|---|---|---|---|
| Force, N | 1.171 | 1.296 | 1.428 | 1.089 | 1.184 | 1.338 | 1.070 | 1.227 | 1.367 |
| Energy, Nm x e-4 | 2.2 | 3.73 | 5.16 | 1.46 | 1.80 | 2.73 | 0.82 | 1.29 | 2.18 |
| Displacement, mm | 0.541 | 0.780 | 0.915 | 0.313 | 0.428 | 0.413 | 0.179 | 0.238 | 0.307 |

Spat Test with RC Probe

| | | | | | | | | | |
|---|---|---|---|---|---|---|---|---|---|
| Force, N | 1.300 | 1.265 | 1.158 | 1.124 | 1.045 | 1.087 | 1.072 | 1.027 | 1.121 |
| Energy, Nm x e-4 | 3.08 | 3.08 | 3.45 | 2.02 | 2.00 | 2.06 | 1.40 | 1.51 | 1.98 |
| Displacement, mm | 0.600 | 0.648 | 0.672 | 0.370 | 0.381 | 0.444 | 0.251 | 0.295 | 0.345 |

HDPE

| | | | | | | | | | |
|---|---|---|---|---|---|---|---|---|---|
| 15 min. Peel | 0.6 | 1.0 | 1.4 | 0.5 | 0.8 | 1.1 | 0.5 | 0.9 | 1.1 |
| 24 hr. Peel | 0.6 | 1.1 | 1.3 | 0.5 | 1.0 | 1.3 | 0.5 | 0.9 | 1.2 |
| SPAT Force | 1.171 | 1.296 | 1.428 | 1.089 | 1.184 | 1.338 | 1.070 | 1.227 | 1.367 |
| SPAT Energy | 2.2 | 3.73 | 5.16 | 1.46 | 1.80 | 2.73 | 0.82 | 1.29 | 2.18 |
| Shear, hrs | 25.83 | 8 | 5.08 | 213.33 | 213.33 | 213.33 | 213.33 | 213.33 | 213.33 |
| Displacement, μ | 541 | 780 | 915 | 313 | 428 | 413 | 179 | 238 | 307 |

TABLE III
Pre-comb Prelm. Work DOE: Polymer D (EHA/VP/AA* 78/20/2), AAA, Foral 85 *EHA = 2-Ethylhexyl
Acrylate, VP = Vinyl Pyrrolidone, AA = Acrylic Acid

| | Example | | | | | | | | |
|---|---|---|---|---|---|---|---|---|---|
| | #10 | #11 | #12 | #13 | #14 | #15 | #16 | #17 | #18 |
| | Polymer | | | | | | | | |
| | Polymer | Polymer | Polymer | Polymer | Polymer | Polymer | Polymer | Polymer | Polymer |
| | D | D | D | D | D | D | D | D | D |
| % AAA | 0.15% | 0.15% | 0.15% | 0.33% | 0.33% | 0.33% | 0.50% | 0.50% | 0.50% |
| % Foral 85 | 0% | 12.5% | 25% | 0% | 12.5% | 25% | 0% | 12.5% | 25% |
| Ct. Wt. g/m* | 33.0 | 33.6 | 35.0 | 31.8 | 35.2 | 32.2 | 31.7 | 33.5 | 35.4 |

Facestock: XL1001 white vinyl

| | | | | | | | | | |
|---|---|---|---|---|---|---|---|---|---|
| Shear 500 g, | 560 sp | 489 sp | 418 sp | 10295 sp | 6172 sp | 4447 sp | 14250+ | 10016+ | 10016+ |
| ½″ x ½″, RT, min. | | | | | | | | | |
| Peel 180° off SS | | | | | | | | | |
| 15 min., lb/in | 4.0 | 4.2 | 4.5 | 3.5 | 3.6 | 4.3 | 3.3 | 3.6 | 3.9 |
| 24 hr., lb/in | 4.3 | 4.6 | 5.1 | 3.9 | 4.1 | 4.8 | 3.6 | 4.0 | 4.3 |
| Peel 180° off HDPE | | | | | | | | | |
| 15 min., lb/in | 1.0 | 1.3 | 1.6 | 0.9 | 1.2 | 1.6 | 0.9 | 1.3 | 1.4 |
| 24 hr., lb/in | 1.0 | 1.3 | 1.7 | 1.0 | 1.3 | 1.6 | 1.0 | 1.3 | 1.6 |

Peel 180° off Automotive Panel DuPont GEN IV

| | | | | | | | | | |
|---|---|---|---|---|---|---|---|---|---|
| 15 min., lb/in | 2.7 | 2.7 | 3.3 | 2.4 | 2.6 | 2.8 | 2.1 | 2.2 | 2.7 |
| 24 hr., lb/in | 3.2 | 3.5 | 4.1 | 2.9 | 3.2 | 3.6 | 2.7 | 2.9 | 3.3 |

Spat Test

| | | | | | | | | | |
|---|---|---|---|---|---|---|---|---|---|
| Force, N | 2.530 | 2.891 | 2.565 | 2.473 | 2.807 | 2.823 | 2.891 | 2.801 | 2.456 |
| Energy, Nm x e-5 | 32.9 | 34.3 | 42.3 | 24.6 | 29.7 | 35.9 | 23.8 | 26.9 | 27.4 |

Spat Test, PE Probe

| | | | | | | | | | |
|---|---|---|---|---|---|---|---|---|---|
| Force, N | 1.419 | 1.701 | 1.574 | 1.782 | 1.486 | 1.755 | 1.623 | 1.793 | 1.765 |
| Energy, Nmm | 0.580 | 0.234 | 0.174 | 0.22 | 0.172 | 0.514 | 0.280 | 0.343 | 0.442 |
| Displacement, mm | 0.560 | 0.374 | 0.257 | 0.286 | 0.364 | 0.719 | 0.432 | 0.418 | 0.624 |

Combi Spat Test, PE Probe

| | | | | | | | | | |
|---|---|---|---|---|---|---|---|---|---|
| Force, N | | 1.808 | 1.490 | 1.601 | 2.442 | 1.752 | 1.586 | 2.016 | 1.812 |
| Energy, Nmm | n/a | 0.448 | 0.161 | 0.221 | 0.625 | 0.499 | 0.324 | 0.970 | 0.828 |
| Displacement, mm | | 1.002 | 0.530 | 0.619 | 0.926 | 1.187 | 0.477 | 0.913 | 1.583 |

Sp = split, cl = clean, st = stain, jp = jerky peel, m = mixed

TABLE IV
Design Experiments: Materials Chosen for Combinatorial
Study using HDPE SPAT Four (4)

| | | | Six (6) Tackifying | | Three (3) AAA |
|---|---|---|---|---|---|
| Polymer | Composition | Tg | Resins | | Crossliner Levels |
| C | EHA/Vac/AA/GMA | −24 | Foral AX | 1 | 0.15% |
| | 67.9/27/5/0.14 | | | | |
| A | IOA/AA 93/7 | −39 | Foral 85 | 2 | 0.33% |
| G | EHA/MA/Vac/AA 89/5/4/2 | | SB ester 10 | 3 | 0.67% |
| F | EHA/BA/Vac/AA 78/14/4/4 | −49 | Kristalex 3070 | | |
| | | | Piccotex 75 | | |
| | | | Hercotac 2010 | | |

EHA = 2-Ethylhexyl Acrylate, Vac = Vinyl Acetate, AA = Acrylic Acid, GMA = Glycidyl Methacrylate, IOA = Isooctyl Acrylate, MA = Methyl Acrylate, BA = Butyl Acrylate

2. Designing Experiments

Starting components were then selected and desired target performance was chosen. Table IV shows that the starting components for this combinatorial study were four (4) polymers (three from the above compatibility study), all six (6) tackifying resins (Foral 85, Foral AX, SB ester 10, Hercotec 2010, Kristalex 3070, and Piccotac 75) at three levels 10%-30%-50% by weight of dry polymer and three (3) levels of AAA crosslinker (0.15%, 0.33%, 0.67% of dry polymer) for each formulation of polymer and tackifier.

The desired target adhesion performance was that of a 1-mil transfer tape, Y-9458 available from 3M.

Target adhesion performance from conventional testing and the AAT were as follows:

Conventional Testing

HDPE 180° Peel, 20 min=1.5 lb/in,

24 hr=1.7 lb/in,

Shear=530 min.

AAT,

Force=1.42 N,

Energy=0.58 Nmm×10 (superscript: −4),

Displacement=0.56 mm.

3. Dispensing Starting Components

Each polymer with 6 tackifiers at three levels and each combination of polymer and tackifier at three crosslinker level resulted in 54 different formulations. These were metered out into two mother well plates, 48 in the first and 6 in the second, by the Packard Multiprobe® Liquid Handler (Packard Instrument Company of Meriden, Conn.). A calculated amount of methyl red dye in toluene was added to each well. The amount added in each well was approx. 0.15% by weight of the dry polymeric mix. Precautions were taken to minimize evaporation of the carrier solvents from the wells by covering the mother well plates with a adhesive coated film.

All weights were recorded after dispensing for each component and a correct accounting of all materials added into a well plate was maintained by a computer program. Cross contamination was avoided by using fresh disposable tips for each new material. Error checks were done in the program at reasonable intervals so that the material accounting could be relied upon. Each well hereby had a unique established composition from these calculations.

4. Mixing Dispensed Formulations

A powered micro turbine impeller was used to mix each well thoroughly using the Asymtek XYZ motion unit and the impellers were washed clean in a toluene bath after each well was mixed. In later studies, we used a V P Scientific magnetic levitation stirrer to thoroughly mix the contents of each well using Teflon coated disposable balls in each well. The open air time was minimized for the well plate and the plate was covered with adhesive coated film to minimize evaporation.

5. Depositing Formulations and Processing Formulations

The objective here was to deposit the mixed formulations onto a substrate and then process or flatten the deposited formulation into a coating. We selected a 2-mil PET substrate for coating. We used the Omega coater to coat the formulation. We laminated the PET film with a roller on top of the silicone template ensuring a good seal for the well bottom to form the daughter well plate. We then pipetted three different volumes of mixture from each composition in the mother well plate into the wells of the daughter plate. Each well formulation with its three different volumes was duplicated onto the daughter well plate. In this fashion eight (8) formulations were cast onto a single 48 well daughter plate. Drying during dispensing into daughter wellplates was minimized so as to allow the dispensed micro quantities of solution to spread uniformly in the daughter well plate prior to drying. A flexible cover paper was placed on top of the daughter plate as it was spun in the Omega coater to form uniform coatings on the PET bottom of the daughter wellplates.

6. Dry/Cure

The spun daughter plate/template assembly was put in an oven at 70° C. for 15 mins to slowly evaporate the residual solvent and simultaneously cure the polymer. Then the daughter plate/template assembly was cooled in a freezer to facilitate the clean removal of the template from the coated PET. This operation yielded a PET sheet with uniform spot coatings of different composition in each spot. The open face adhesive was protected from dust by placing a release sheet cover onto it.

7. Test Materials

a. The spots were visually inspected for any evidence of incompatibility. When the materials were incompatible, the coatings were hazy and not transparent. Incompatible coatings were rejected for further adhesion testing.

b. The thickness of each coating was measured by using a MicroQuant® spectrophotometer, available from Merck & Co., Inc., with a well plate reader. The spectrophotometer measured the absorbance of the coating due to the dye at 482 nanometers wavelength. The thicknesses were calculated using De Beers Law for each composition and were recorded in the database for each spot. Incompatible coatings had very high absorbance and were rejected again at this stage.

c. The Avery Adhesive Test (AAT) was run using a high density polyethylene probe on each coating in duplicate and each measurement resulted in three parameters being identified by the test.—energy, first peak and displacement. These parameter values were recorded into a database for each spot coating.

8. Analyze Test Results

We imported all data generated above steps into the SPOTFIRE Visualization program, which is available from Spotfire of Amherst, Mass. We now had AAT data on compatible formulations for each coating in the array along with the with respective thickness of the coating. We also generated similar data for the target material. We henceforth could compare the adhesive performance of targets with our formulation compositions and select promising materials for further consideration.

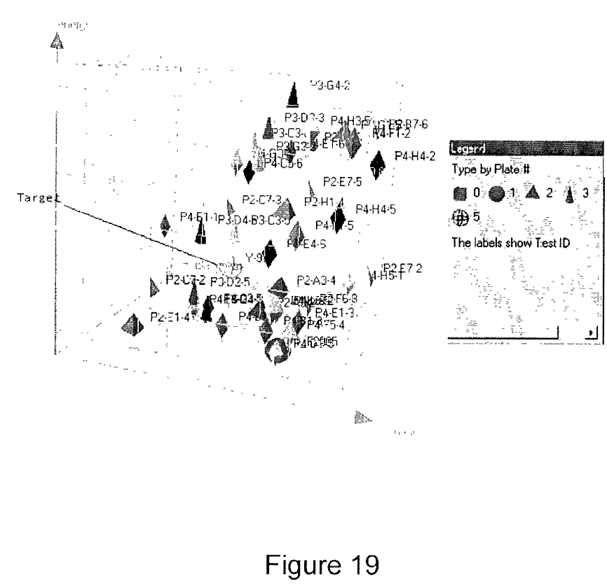

The SpotFire software enables proper visualization in color of all points with 6 degrees of freedom in representation of a point. The points while shown here in a two dimensional graph can also be plotted on a three dimensional plot of First Peak, Energy and Displacement representing the tack, peel and shear adhesion properties respectively. FIG. 19 shows one such 3 dimensional plot where the points are plotted along with the target. One can zoom into the 3-D space in the graph to enable better visualization of differences between the target and close formulations. This then enables one to come up with a final cut of candidates for further validation studies that perform near the performance of the selected target.

The AAT performance data of First Peak, Energy and Displacement is usually normailzed at the target adhesive's coat weight so that we compare performances between the target and our formulations at the same thickness. One may also normalize with respect to other parameters such as raw material cost, etc.

TABLE V(a)
Analyze Test Results: Ranking of Best Combi Samples (1-18)
to be Coated and Tested for Combi Validation

| Sample | | Plate | | | % | | | |
|---|---|---|---|---|---|---|---|---|
| # | Test ID | # | tackifier | % AAA | tackifier | Force | displacement | energy |
| | Y-9485 | | | | | 1.419 | 0.58 | 0.56 |
| | Y-927 | 5 | | | | 1.492 | 1.081 | 0.648 |
| 1 | F3005 | 0 | SB-10 | 0.15 | 20 | 1.808 | 1.002 | 0.448 |
| 2 | E1002 | 0 | F-85 | 0.33 | 20 | 1.49 | 0.530 | 0.161 |
| 3 | H1002 | 0 | F-85 | 0.33 | 30 | 1.601 | 0.6190 | 0.221 |
| 4 | D7003 | 0 | H-2010 | 0.15 | 30 | 2.442 | 0.926 | 0.625 |
| 5 | 1_H2001 | 1 | F-AX | 0.15 | 60 | 1.752 | 1.187 | 0.499 |
| 6 | 1_E2004 | 1 | F-AX | 0.33 | 40 | 1.586 | 0.477 | 0.324 |
| 7 | P2-H1-1 | 2 | F-85 | 0.33 | 30 | 2.016 | 0.913 | 0.97 |
| 8 | P2-A7-5 | 2 | Hercotac 2010 | 0.15 | 30 | 1.812 | 1.583 | 0.828 |
| 9 | P2-C7-2 | 2 | Hercotac 2010 | 0.67 | 30 | 1.248 | 0.851 | 0.623 |
| 10 | P2-B7-2 | 2 | Hercotac 2010 | 0.33 | 30 | 2.05 | 1.177 | 1.02 |
| 11 | P2-E7-3 | 2 | Hercotac 2010 | 0.33 | 50 | 1.909 | 1.199 | 0.936 |
| 12 | P3-A2-2 | 3 | F-85 | 0.67 | 50 | 2.158 | 1.076 | 1.622 |
| 13 | P3-D2-5 | 3 | Foral AX | 0.67 | 10 | 1.425 | 0.874 | 0.631 |
| 14 | P3-G3-2 | 3 | SB ester 10 | 0.33 | 30 | 1.637 | 0.877 | 0.822 |
| 15 | P4-D1-1 | 4 | F-85 | 0.15 | 30 | 1.180 | 2.899 | 0.616 |
| 16 | P4-G2-5 | 4 | Foral AX | 0.67 | 30 | 1.414 | 2.660 | 0.796 |
| 17 | P4-B4-1 | 4 | SB ester 10 | 0.33 | 50 | 1.824 | 2.365 | 0.694 |
| 18 | P4-B5-1 | 4 | Kristalex 3070 | 0.15 | 50 | 1.824 | 2.819 | 0.540 |
| Samples Far Away From Target | | | | | | | | |
| 19 | P3-D3-1 | 3 | SB ester 10 | 0.33 | 10 | 1.754 | 0.208 | 0.090 |
| 20 | P2-C4-1 | 2 | SB ester 10 | 0.67 | 50 | 2.042 | 0.126 | 0.095 |
| 21 | P2-F1-4 | 2 | F-85 | 0.67 | 20 | 1.972 | 0.373 | 0.271 |
| 22 | P4-C7-3 | 4 | Hercotac 2010 | 0.67 | 30 | 0.960 | 0.720 | 0.040 |

| | | |
|---|---|---|
| Plate 0 | Polymer C | EHA/Vac/AA/GMA |
| Plate 1 | Polymer C | EHA/Vac/AA/GMA |
| Plate 2 | Polymer A | IOA/AA |
| Plate 3 | Polymer G | EHA/MA/Vac/AA |
| Plate 4 | Polymer F | EHA/BA/Vac/AA |
| Plate 5 | Y-9458 | |

| | | | | % | | | | |
|---|---|---|---|---|---|---|---|---|
| Test ID | Plate # | Tackifier | % AAA | tackifier | 1^{st} peak | displacement | Energy | Thickness |
| Y-927 | 5 | | | | 1.492 | 1.081 | 0.648 | 2.00 |
| F3005 | 0 | SB-10 | 0.15 | 20 | 1.808 | 1.002 | 0.448 | 2.13 |
| 1_H2001 | 1 | F-AX | 0.15 | 60 | 1.752 | 1.187 | 0.499 | 2.01 |
| 1_H2004 | 1 | F-AX | 0.15 | 60 | 1.8 | 1.097 | 0.462 | 1.98 |
| P2-B7-2 | 2 | Hercotac | 0.33 | 30 | 2.05 | 1.177 | 1.02 | |
| | | 2010 | | | | | | |
| P2-E7-3 | 2 | Hercotac | 0.33 | 50 | 1.909 | 1.199 | 0.936 | |
| | | 2010 | | | | | | |
| P2-E7-5 | 2 | Hercotac | 0.33 | 50 | 1.792 | 0.996 | 0.775 | |
| | | 2010 | | | | | | |
| P3-A2-2 | 3 | Foral 85 | 0.67 | 50 | 2.158 | 1.076 | 1.622 | 1.89 |

Criteria: Coatweight = 2 mils; <Displacement; >Energy; >fp

| | | | | % | 1^{st} | | | |
|---|---|---|---|---|---|---|---|---|
| Test ID | Plate # | Tackifier | % AAA | tackifier | peak | E/D | Energy | Thickness |
| Y-927 | 5 | | | | 1.492 | 0.59944496 | 0.648 | 2.00 |
| E1002 | 0 | F-85 | 0.33 | 20 | 1.49 | 0.52960526 | 0.161 | 2.10 |
| E1005 | 0 | F-85 | 0.33 | 20 | 1.574 | 0.60504202 | 0.144 | 2.00 |
| H1002 | 0 | F-85 | 0.33 | 30 | 1.601 | 0.61904762 | 0.221 | 1.97 |
| H1005 | 0 | F-85 | 0.33 | 30 | 1.597 | 0.65934066 | 0.18 | 1.85 |
| 1_E2004 | 1 | F-AX | 0.33 | 40 | 1.586 | 0.47717231 | 0.324 | 2.04 |

Criteria: >e/d; >fp; coatwght: 2 mils

| | | | | % | 1^{st} | | | | |
|---|---|---|---|---|---|---|---|---|---|
| Test ID | Plate # | Tackifier | % AAA | tackifier | peak | displacement | Energy | E/D | thickness |
| Y-927 | 5 | | | | 1.492 | 1.081 | 0.648 | 0.599445 | 2 |
| D7003 | 0 | H-2010 | 0.15 | 30 | 2.442 | 0.926 | 0.625 | 0.674946 | |
| D7006 | 0 | H-2010 | 0.15 | 30 | 2.442 | 0.945 | 0.661 | 0.699471 | |
| P2-H1-1 | 2 | F-85 | 0.33 | 30 | 2.016 | 0.913 | 0.97 | 1.062432 | 2.06 |
| P2-H1-4 | 2 | F-85 | 0.33 | 30 | 1.776 | 0.79 | 0.763 | 0.965823 | 2.09 |
| P2-A7-5 | 2 | Hercotac | 0.15 | 30 | 1.812 | 1.583 | 0.828 | 0.523057 | |
| | | 2010 | | | | | | | |
| P2-B7-2 | 2 | Hercotac | 0.33 | 30 | 2.05 | 1.177 | 1.02 | 0.86661 | |
| | | 2010 | | | | | | | |
| P2-C7-2 | 2 | Hercotac | 0.67 | 30 | 1.248 | 0.851 | 0.623 | 0.73208 | |
| | | 2010 | | | | | | | |
| P2-E7-2 | 2 | Hercotac | 0.33 | 50 | 2.07 | 0.882 | 0.678 | 0.768707 | |
| | | 2010 | | | | | | | |
| P2-E7-5 | 2 | Hercotac | 0.33 | 50 | 1.792 | 0.996 | 0.775 | 0.778112 | |
| | | 2010 | | | | | | | |
| P3-D2-5 | 3 | Foral AX | 0.67 | 10 | 1.425 | 0.874 | 0.631 | 0.721968 | 2.468 |
| P3-G3-2 | 3 | SB ester | 0.33 | 30 | 1.637 | 0.877 | 0.822 | 0.937286 | 1.951 |
| | | 10 | | | | | | | |

Criteria: >FP/D; >E; Coatweight: 2 mils.
Plate 0; Plate 1 : Polymer C; Plate 2: Polymer A; Plate 3: Polymer G; Plate 4: Polymer F; Plate 5: Y-9458

TABLE V(b)
Analyze Test Results: Ranking of Best Combi Samples (cont.)

| | Tar- | Example # | | | | | | |
|---|---|---|---|---|---|---|---|---|
| | get | #19 | #20 | #21 | #22 | #23 | #24 | #25 |
| | Polymer | | | | | | | |
| | | Poly- | Poly- | Poly- | Poly- | Poly- | Poly- | Poly- |
| | Y- | mer | mer | mer | mer | mer | mer | mer |
| | 9458 | C | C | C | C | C | C | A |
| % AAA | Con- | 0.15% | 0.33% | 0.33% | 0.15% | 0.15% | 0.33% | 0 33% |
| | trol | | | | | | | |
| Tackifying | | SB 10 | Foral | Foral | Herc- | Foral | Foral | Foral |
| Resin | | | 85 | 85 | otac | AX | AX | 85 |
| | | | | | 2010 | | | |
| Amount | | 20% | 20% | 30% | 30% | 60% | 40% | 30% |
| Tackifying | | | | | | | | |
| Resin | | | | | | | | |
| Ct. Wt. | 29.3 | 30.2 | 30.3 | 28.9 | 30.1 | 30.2 | 30.1 | 31.7 |
| g/m2 | | | | | | | | |

Facestock: 1.5 mil Mylar

| | | | | | | | | |
|---|---|---|---|---|---|---|---|---|
| Shear 500 g, | 531 | 3715 | 10,096+ | 10,094+ | 1603 | 95 | 3727 | 11,098+ |
| ½′ x ½″, | sp | sp | | | sp | sp | sp | |
| RT, min. | | | | | | | | |

Peel 180° off HDPE

| | | | | | | | | |
|---|---|---|---|---|---|---|---|---|
| 15 min., | 1.5 | 1.4 | 1.4 | 1.4 | 0.8 | 0.7 | 1.4 | 1.2 |
| lb/in | cl | jp | jp | jp | jp | jp | jp | cl |
| 24 hr., | 1.7 | 1.3 | 1.3 | 1.5 | 1.0 | 1.4 | 1.6 | 1.5 |
| lb/in | cl | jp | jp | jp | jp | jp | jp | cl |

Spat Test, PE Probe

| | | | | | | | | |
|---|---|---|---|---|---|---|---|---|
| Force, N | 1.419 | 1.701 | 1.574 | 1.782 | 1.486 | 1.755 | 1.623 | 1.793 |
| Energy, | 0.580 | 0.234 | 0.174 | 0.22 | 0.172 | 0.514 | 0.280 | 0.343 |
| Nmm | | | | | | | | |
| Dis- | 0560 | 0.374 | 0.257 | 0.286 | 0.364 | 0.719 | 0.432 | 0.418 |
| placement, | | | | | | | | |
| mm | | | | | | | | |

Combi Spat Test, PE Probe

| | | | | | | | | |
|---|---|---|---|---|---|---|---|---|
| Force, N | | 1.808 | 1.490 | 1.601 | 2.442 | 1.752 | 1.586 | 2.016 |
| Energy, | N/a | 0.448 | 0.161 | 0.221 | 0.625 | 0.499 | 0.324 | 0.970 |
| Nmm | | | | | | | | |
| Dis- | | 1.002 | 0.530 | 0.619 | 0.926 | 1.187 | 0.477 | 0.913 |
| placement, | | | | | | | | |
| mm | | | | | | | | |

| | | | | |
|---|---|---|---|---|
| Polymer | Polymer | EHA = 2- | Vac = | AA = |
| C = | A = | Ethylhexyl | Vinyl | Acrylic |
| EHA/Vac/ | IOA/AA | Acrylate | acetate | Acid |
| AA/GMA | 93/7 | | | |
| 67.9/27/ | | | | |
| 5/0.14 | | | | |

Example

| | | | |
|---|---|---|---|
| #26 | #27 | #28 | #29 |

Polymer

| | Poly- | Poly- | Poly- | Poly- |
|---|---|---|---|---|
| | mer | mer | mer | mer |
| | A | A | A | A |
| % AAA | 0.15% | 0.33% | 0.67% | 0.33% |
| Tackifying | Herc- | Herc- | Herc- | Herc- |
| Resin | otac | otac | otac | otac |
| | 2010 | 2010 | 2010 | 2010 |
| Amount | 30% | 30% | 30% | 50% |
| Tackifying | | | | |
| Resin | | | | |
| Ct. Wt. | 30.7 | 30.5 | 29.8 | 30.5 |
| g/m2 | | | | |
| Facestock: 1.5 mil Mylar | | | | |
| Shear 500 g, | 316 | 10,051+ | 11,096+ | 4,023 |
| ½′ x ½″, | sp | | | sp |
| RT, min. | | | | |
| Peel 180° off HDPE | | | | |
| 15 min., | 1.4 | 1.2 | 1.0 | 1.6 |
| lb/in | cl | cl | cl | cl |
| 24 hr., | 1.5 | 1.3 | 1.0 | 0.8 |
| lb/in | cl | cl | cl | jp |
| Spat Test, PE Probe | | | | |
| Force, N | 1.765 | 1.533 | 1.532 | 1.560 |
| Energy, | 0.442 | 0.226 | 0.15 | 0.266 |
| Nmm | | | | |
| Dis- | 0.624 | 0.365 | 0.227 | 0.383 |
| placement, | | | | |
| mm | | | | |
| Combi Spat Test, PE Probe | | | | |
| Force, N | 1.812 | 2.050 | 1.248 | 1.909 |
| Energy, | 0.828 | 1.020 | 0.623 | 0.936 |
| Nmm | | | | |
| Dis- | 1.583 | 1.177 | 0.851 | 1.199 |
| placement, | | | | |
| mm | | | | |

| | | |
|---|---|---|
| Polymer | GMA = | IOA = |
| C = | Glycidyl | Isooctyl |
| EHA/Vac/ | Methacrylate | Acrylate |
| AA/GMA | | |
| 67.9/27/ | | |
| 5/0.14 | | |

TABLE VI(a)
Validation of Combi Study: Best 18 Candidates and 4 Poor Candidates (#1-11)

| | Example # | | | | | | | | | | |
|---|---|---|---|---|---|---|---|---|---|---|---|
| | #30 | #31 | #32 | #33 | #34 | #35 | #36 | #37 | #38 | #39 | #40 |
| | Polymer | | | | | | | | | | |
| | Polymer | Polymer | Polymer | Polymer | Polymer | Polymer | Polymer | Polymer | Polymer | Polymer | Polymer |
| | G | G | G | F | F | F | F | G | A | A | F |
| % AAA | 0.67% | 0.67% | 0.33% | 0.15% | 0.67% | 0.33% | 0.15% | 0.33% | 0.67% | 0.67% | 0.67% |
| Tackifying | Foral 85 | Foral AX | SB 10 | Foral 85 | Foral AX | SB 10 | Kristalex | SB 10 | SB 10 | Foral 85 | Hercotac |
| Resin | | | | | | | | | | | |
| Amount | 50% | 10% | 30% | 30% | 30% | 50% | 50% | 10% | 50% | 20% | 30% |
| Tackifying | | | | | | | | | | | |
| Resin | | | | | | | | | | | |
| Ct.Wt. g/m2 | 30.1 | 30.3 | 31.7 | 29.8 | 31.4 | 29 | 31 | 28.7 | 30.2 | 28.0 | 28.7 |

Facestock: 1.5 mil Mylar

| | | | | | | | | | | | |
|---|---|---|---|---|---|---|---|---|---|---|---|
| Shear 500 g, | 1261 st | 285 st | 1265 st | 20 sp | 285 sp | 232 sp | 53 sp | 1956 st | 14,200+ | 14,200+ | 11,380 |
| ½′ x ½″, | | | | | | | | | | | m |
| RT, min. | | | | | | | | | | | |

Peel 180° off HDPE

| | | | | | | | | | | | |
|---|---|---|---|---|---|---|---|---|---|---|---|
| 15 min., lb/in | 1.0 cl | 0.2 cl | 0.7 cl | 1.4 cl | 0.7 cl | 1.9 cl | 0.8 cl | 0.4 cl | 0.3 tr | 0.8 cl | 0.7 cl |
| 24 hr., lb/in | 1.2 cl | 0.4 cl | 0.8 cl | 1.6 cl | 1.1 cl | 2.0 jp | 0.8 cl | 0.4 cl | 0.3 tr | 0.6 cl | 0.6 cl |

Spat Test, PE Probe

| | | | | | | | | | | | |
|---|---|---|---|---|---|---|---|---|---|---|---|
| Force, N | 1.286 | 1.068 | 1.332 | 1.741 | 1.35 | 1.568 | 1.574 | 1.015 | 1.751 | 1.423 | 1.160 |
| Energy, Nmm | 0.336 | 0.157 | 0.357 | 0.645 | 0.314 | 0.649 | 0.366 | 0.148 | 0.174 | 0.140 | 0.112 |
| Displacememt, | 0.502 | 0.318 | 0.508 | 2.852 | 0.667 | 1.997 | 0.917 | 0.289 | 0.254 | 0.212 | 0.211 |
| mm | | | | | | | | | | | |

Combi Spat Test, PE Probe

| | | | | | | | | | | | |
|---|---|---|---|---|---|---|---|---|---|---|---|
| Force, N | 2.158 | 1.425 | 1.637 | 1.180 | 1.414 | 1.824 | 1.824 | 1.754 | 2.042 | 1.972 | 0.960 |
| Energy, Nmm | 1.622 | 0.631 | 0.822 | 0.616 | 0.796 | 0.694 | 0.540 | 0.090 | 0.095 | 0.271 | 0.040 |
| Displacememt, | 1.076 | 0.874 | 0.877 | 2.899 | 2.660 | 2.365 | 2.819 | 0.208 | 0.126 | 0.373 | 0.720 |
| mm | | | | | | | | | | | |

sp = split, cl = clean, st = stain, jp = jerky peel, m = mixed
Polymer G = EHA/MA/Vac/AA 89/5/4/2, Polymer F = EHA/BA/Vac/AA 78/14/4/4, Polymer A = IOA/AA 93/7
Table VI(b). Validation of Combi Study: Best 18 Candidates and 4 Poor Candidates (#12-22)

TABLE VI(c)
Validation of Combi Study: Energy and Peel Test
for Best 18 Candidates and 4 Poor Candidates

| Energy | Combi | Lab Coated | Energy | |
|---|---|---|---|---|
| CombiSPAT | Sample | Example | LabSPAT | 15 min Peel |
| 0.97 | 1 | 19 | 0.34 | 1.2 |
| 0.83 | 2 | 20 | 0.44 | 1.4 |
| 1.02 | 3 | 21 | 0.23 | 1.2 |
| 0.62 | 4 | 22 | 0.15 | 1.0 |
| 0.94 | 5 | 23 | 0.27 | 1.6 |
| 0.45 | 6 | 24 | 0.24 | 1.4 |
| 0.16 | 7 | 25 | 0.17 | 1.4 |
| 0.22 | 8 | 26 | 0.22 | 1.4 |
| 0.63 | 9 | 27 | 0.17 | 0.8 |
| 0.50 | 10 | 28 | 0.51 | 0.7 |
| 0.32 | 11 | 29 | 0.28 | 1.4 |
| 1.62 | 12 | 30 | 0.34 | 1.0 |
| 0.63 | 13 | 31 | 0.16 | 0.2 |
| 0.82 | 14 | 32 | 0.36 | 0.7 |
| 0.62 | 15 | 33 | 0.65 | 1.4 |
| 0.80 | 16 | 34 | 0.31 | 0.7 |
| 0.69 | 17 | 35 | 0.65 | 1.9 |
| 0.54 | 18 | 36 | 0.37 | 0.8 |
| 0.09 | 19 | 37 | 0.15 | 0.4 |
| 0.95 | 20 | 38 | 0.17 | 0.3 |
| 0.27 | 21 | 39 | 0.14 | 0.8 |
| 0.04 | 22 | 40 | 0.11 | 0.7 |

TABLE VII
Validation of Combi-Science Study: Tackifying
Acrylic PSA's - Best Hits

| | Y-9458 | Example # 19 | Example # 35 |
|---|---|---|---|
| Polymer | Target | Polymer A | Polymer F |
| % AAA | | 0.33% | 0.33% |
| Tackifying | Rosin | Foral 85 | SB 10 |
| Resin | Ester&Acid | | |
| Amount | ˜47% | 30% | 50% |
| Tackifying | | | |
| Resin | | | |
| Ct. Wt. g/m² | 29.3 | 31.7 | 29 |
| Facestock: | | | |
| 1.5 mil Mylar | | | |
| Shear | | | |
| 500 g, 1/2″ × 1/2″, | 531 sp | 11,098+ | 232 sp |
| RT, min. | | | |
| Peel 180° off SS | | | |
| 15 min., lb/in | 3.6 st | 4.0 cl | 5.4 sp |
| 24 hr, lb/in | 4.5 m | 4.0 cl | 6.1 sp |
| Peel 180° off HDPE | | | |
| 15 min., lb/in | 1.5 cl | 1.2 cl | 1.9 cl |
| 24 hr., lb/in | 1.7 cl | 1.5 cl | 2.0 jp |
| Peel 180° off | | | |
| Automotive Panel | | | |
| Gen. 4 DuPont | | | |
| 15 min., lb/in | 3.0 cl | 2.8 cl | 4.3 cl |
| 24 hr., lb/in | 3.7 cl | 3.6 cl | 5.9 sp |
| Spat Test, | | | |
| PE Probe | | | |
| Force, N | 1.419 | 1.793 | 1.568 |
| Energy, Nmm | 0.580 | 0.343 | 0.649 |
| Displacememt, mm | 0.560 | 0.418 | 1.997 |
| Combi Spat Test, | | | |
| PE Probe | | | |
| Force, N | | 2.016 | 1.824 |
| Energy, Nmm | n/a | 0.970 | 0.694 |
| Displacememt, mm | | 0.913 | 2.365 |

sp = split,
cl = clean,
st = stain,
jp = jerky peel,
m = mixed

It is noted that the energy, first peak and displacement data with respect to sample thickness may be fit to linear regression curves. Using the linear regression curves, energy, first peak and displacement may be calculated for one or more target thickness. The calculations may be plotted in three dimensions, for example. Data from competing compounds may also be plotted, to aid in selecting the best adhesive.

### Validation

After testing the four (4) polymers, validation of the combinatorial study was under taken to evaluate one or two promising candidates. Of the 250 formulations evaluated, Table V(a) shows the best (ranking) 18 combinatorial samples based on AAT high Energy and high Force and low Displacement values, and four (4) poor samples that are far away from the target and are expected to do poorly. Table V(b) illustrates pre-ranked data upon which rankings are conducted. The 18 combinatorial samples represent 7% of the population, which means we are discarding 93% of the population. This is what combinatorial methods disclosed herein provide: the ability to identify the best (the 18 combinatorial samples) out of the total amount ore (the total population of combinatorial formulations) for further study. Many of these hits had higher AAT Energy and Force, and lower displacement, than the target adhesive desired. The test data for these 22 combinatorial formulations (18+4) are provided in Tables VI (a)-(c). The formulations deemed to be the best are listed in Table VII.

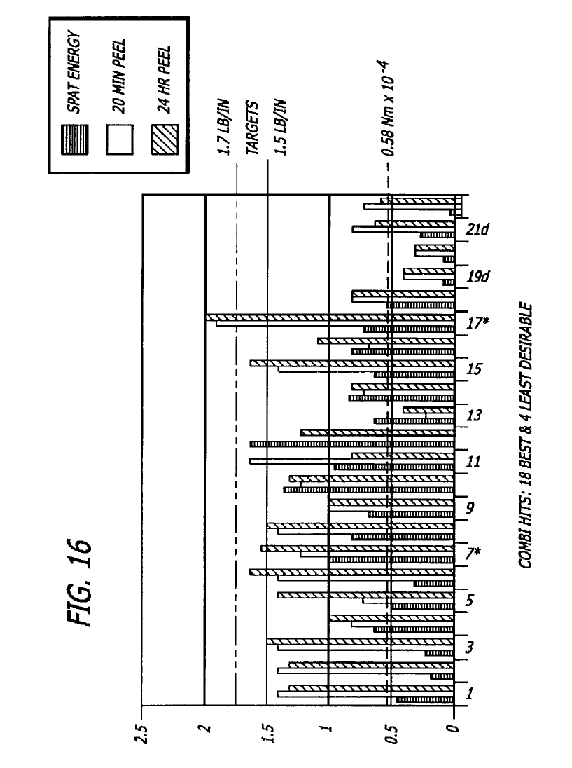

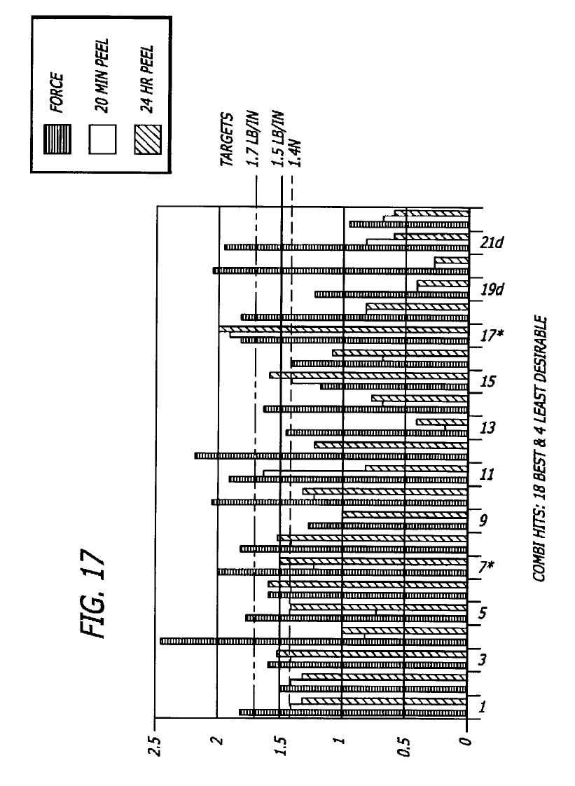

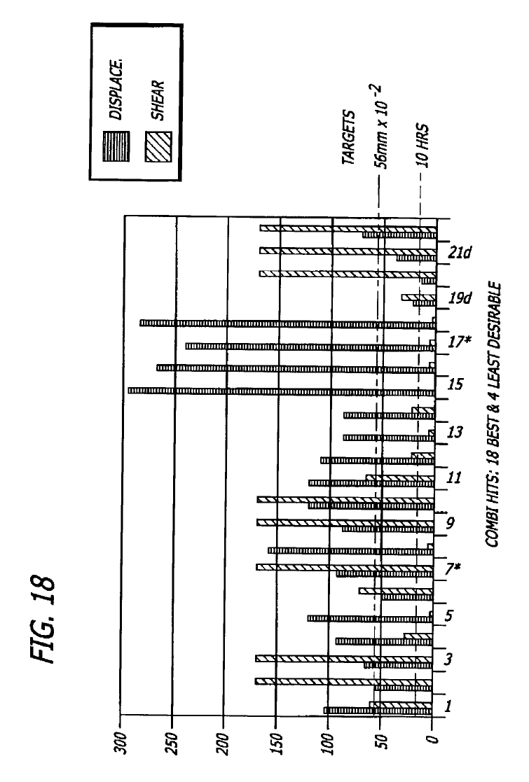

The validation step comprised formulation, lab coating, drying, and lab testing (peel and shear testing per ASTM specifications) all 22 combinatorial samples and comparing them to the combinatorial AAT testing. FIG. 16 shows combinatorial AAT Energy and lab coated peel testing and FIG. 17 shows combinatorial Force and lab coated Peel testing. It was noted that most of the hits (examples) that met the Energy or Force target did not meet the Peel target (a tough target). However, most in that group was respectable with a 1 lb Peel, and there were at least 2 Hits (#7 & #17) identified that warrant further investigation. It should be noted that the first 6 examples (hits) gave a zippy peel which is unacceptable, also example 17 the 24 hour peel was zippy and example 20d gave adhesive transfer mode of failure (zippy peel is a failure mode indicating poor adhesion, adhesive transfer mode of failure indicated poor anchorage to the substrate, both unacceptable results). FIG. 18 shows combinatorial AAT Displacement with lab coated Shear testing. It was noted that the correlation was not good, but also the upper range of crosslinker level was too high, which appeared to have skewed the results.

In closing, it is to be understood that the embodiments of the invention disclosed herein are illustrative of the principles of the invention. Other modifications may be employed which are within the scope of the invention; thus, by way of example, but not limitation, alternative arrangements and methods for providing materials in array formats, as well as other screening/testing apparatus may be utilized. Accordingly, the present invention is not limited to that precisely as shown and described in the present specification.

We claim:

1. A method for making and screening many formulations of pressure sensitive adhesives in a rapid manner to achieve a target adhesion performance from a screened formulation comprising:
specifying desired target adhesion performance for any formulation selecting starting components to be used;
designing a plurality of pressure sensitive adhesive formulations with said starting components using experimental design techniques;
dispensing the said starting components to generate the said plurality of formulations;
mixing each of the said plurality of formulations in order to uniformly disperse the said starting components;
depositing the said plurality of formulations onto a substrate to form an array;
processing all members of—the said array—into a plurality of coatings on the said substrate;
treating of said plurality of coatings using a drying or curing process;
testing the said plurality of coatings for compatibility performance and adhesion performance; and
analyzing the compatibility performance and adhesion performance in order to identify any of the said formulations that display the said desired target performance.

2. The method of claim 1 wherein said starting components comprise at least one of base polymers, tackifiers, and blends of polymers.

3. The method of claim 2 wherein the starting components further comprise at least one of fillers, waxes, cross-linkers and plasticizers.

4. The method of claim 1 wherein the method further comprises the step of screening the plurality of coatings in order to determine compatibility performance by assessing haziness of the plurality of coatings

5. The method of claim 4 wherein the haziness is assessed by measuring absorbance of the said plurality of coatings

6. The method of claim 1 wherein a dye having a known extinction coefficient and concentration comprises at least one starting component of said formulations.

7. The method of claim 6 wherein said dye is utilized for determining the thickness of each of the said plurality of coatings.

8. The method of claim 1 wherein the dispensing of said starting components is performed by a robotic dispenser.

9. The method of claim 8 wherein said robotic dispenser is integrated with a balance.

10. The method of claim 1 wherein the testing for said adhesion performance of the said coatings utilizes a probe tester.

11. The method of claim 10 wherein the AAT is utilized as a probe tester.

12. A rapid method for screening materials to meet target adhesion performance, comprising:
selecting starting components;
designing experimental formulations comprised of said starting components;
compounding said starting components utilizing said experimental formulations in order to provide a plurality of material formulations, each of said plurality of material formulations being comprised of at least two starting components;
applying samples of the plurality of material formulations to a substrate, thereby providing an array of samples of the plurality of materials;
applying a leveling force onto the array of samples;
utilizing a probe tester, having a probe, to test the array of samples of the plurality of materials in order to obtain test results; and
evaluating the test results.

13. The method of claim 12 wherein the force is a centrifugal force.

14 The method of claim 12 wherein the array is formed by placing the formulations into a plurality of receptacles, the receptacles being formed by placing an apertured sheet upon the substrate, thereby forming a plurality of sample receiving wells.

15. The method of claim 12 wherein said designing step further comprises identifying candidate starting components and compounding them at starting ratios.

16. The method of claim 12 wherein the applying step further comprises the use of a multi-receptacle assembly comprised of the substrate and a rubber-based apertured sheet disposed thereon, forming a plurality of sample receiving wells.

17. The method of claim 12, wherein the testing is done with the said substrate mounted upon a platform having an X-Y motion and the probe tester moves in a Z-motion.

18. The method of claim 12, wherein the testing is done with the said substrate mounted upon a platform having an X-Y motion, and the probe tester moves in a Z-motion.

19. The method of claim 12, wherein the probe tester is able to move in an X-Y-Z motion while the said substrate, having the array of samples of the plurality of material formulations disposed thereon, remains stationary.

20. The method of claim 12, wherein the said substrate, having the array of samples of the plurality of material formulations disposed thereon, is able to move in an X-Y-Z motion and the probe tester remains in a fixed position.

21. The method of claim 12, wherein the AAT has a plurality of probes which test the samples of the plurality of material formulations in parallel, to obtain a plurality of test data from a plurality of materials having particular formulations.

22. The method of claim 12, wherein the AAT is utilized to perform tack tests on the array of samples.

23. The method of claim 12, wherein the probe is spherical.

24. The method of claim 23 wherein said probe is articulated.

25. The method of claim 21, wherein said plurality of probes are spherical.

26. The method of claim 25 wherein said plurality of probes are articulated.

27. The method of claim 12, wherein the probe is spherical and has a plurality of raised probing surfaces.

28. The method of claim 12, wherein the AAT is utilized to conduct loop or shear testing of the array of samples of the plurality of materials having particular formulations.

29. The method of claim 12 wherein the plurality of material formulations is further comprised of dye added to the formulations.

30. The method of claim 29 wherein said addition of dye to the material formulations is utilized to determine thickness of samples of the plurality of formulations disposed upon the substrate.

31. The method of claim 30 wherein photometry techniques are utilized to determine thickness of samples of the plurality of material formulations disposed upon the substrate.

32. The method of claim 12, 21 or 23 wherein a solvent is utilized in conjunction with a rotating cleaning device, to clean the probe between tests.

33. The method of claim 12, 21 or 23 wherein a blast of CO2 followed by solvent cleaning is utilized to clean the probes between tests.

34. The method of claim 12, wherein said plurality of materials having particular formulations are pressure sensitive adhesives.

35. An apparatus for characterizing a plurality of materials, comprising:
an array of a plurality of materials disposed upon a substrate;
a platform upon which the substrate is positioned;
a probe connected to a force transducer; coupling means for coupling said apparatus to a computer, said computer providing means for controlling said probe;
automated means for displacing either the probe, the platform or both in any direction; and
recording and analyzing means for recording and analyzing information provided by said probe connected to said force transducer.

36. The apparatus of claim 35 wherein said apparatus has a plurality of probes.

37. The apparatus of claim 36 wherein said plurality of probes is connected to a plurality of force transducers.

38. The apparatus of claim 35 wherein said automated means comprises a step motor.

39. The apparatus of claim 35 wherein said automated means is comprised of a plurality of step motors.

40. The apparatus of claim 35 wherein said probe is utilized to conduct texture analysis of a plurality of material formulations.

41. The apparatus of claim 40 wherein the probe has a geometric shape.

42. The apparatus of claim 35 or 36, wherein the probes are articulated.

43. The apparatus of claim 42 wherein said probe has a plurality of raised probing surfaces.

44. The apparatus of claim 35 wherein the array of a plurality of material formulations is disposed upon a substrate comprised of plastic.

45. The apparatus of claim 35 wherein the substrate is a composition suitable for use as facestock.

46. The apparatus of claim 35 wherein the array of a plurality of material formulations disposed upon a substrate is provided by placing the samples into a plurality of receptacles, the receptacles being formed by placing an apertured sheet upon the substrate, thereby forming a multi-layered casting assembly and plurality of receptacles.

47. The apparatus of claim 46 wherein said multi-layered casting assembly having sample receiving wells, having said plurality of material formulations disposed in the plurality of receptacles, is placed into a centrifuge and subjected to a centrifugal force.

48. The apparatus of claim 47, wherein the multi-layered casting assembly, with the plurality of material formulations disposed in the plurality of receptacles, is covered during centrifugation.

49. The apparatus of claim 47, wherein the centrifuge is constructed to be airtight.

50. The apparatus of claim 49 wherein atmospheric conditions within the centrifuge are varied by a user.

51. The apparatus of claim 50 wherein the atmospheric condition to be varied is selected from the group consisting of temperature, pressure, humidity and gaseous content.

52. The apparatus of claim 47 wherein the plurality of material formulations disposed in the plurality of receptacles are cured during centrifugation.

53. The apparatus of claim 52 wherein the plurality of material formulations disposed in the plurality of receptacles are cured by the application of ultraviolet or ionizing radiation, heat, or microwaves.

54. The apparatus of claim 35 wherein said apparatus is utilized to perform adhesive tests on the array of a plurality of material formulations disposed upon a substrate.

55. The apparatus of claim 35 wherein the array is comprised of rows of plurality of material formulations disposed upon a substrate, each component of the plurality having a different formulation than the other components, disposed upon the same substrate.

56. The apparatus of claim 35 wherein the array is comprised of a plurality of material formulations, each component of the plurality having the same formulation as the other components of the plurality, each disposed upon a differing substrate.

57. The apparatus of claim 35 wherein material having various or similar formulations, and make up the array, are applied onto the substrate at varying thicknesses.

58. The apparatus of claim 35 wherein the apparatus is placed in an environmental chamber and testing is carried out in the environmental chamber.

59. An apparatus for characterizing a plurality of materials, comprising:
an array of a plurality of materials disposed upon a substrate;
a platform upon which the substrate is positioned;
a probe connected to a force transducer, wherein the probe, the platform or both are displaceable; and
the apparatus being in communication with a computer, the computer being adapted to provide instructions to the apparatus, and to record and analyze information provided by said probe.

60. The apparatus of claim 59 wherein motor is provided to displace at least one of the probe and the platform.

61. The apparatus of claim 59 wherein a plurality of motors is provided to displace at least one of the probe and the platform.

62. The apparatus of claim 59 wherein at least one of the probe and the platform, is provided electrically.

63. The apparatus of claim 59 wherein said apparatus has a plurality of probes.

64. The apparatus of claim 59 wherein said probe is utilized to conduct texture analysis of the plurality of materials having various formulations in the array.

65. The apparatus of claim 59 wherein the array of a plurality of materials disposed upon a substrate is provided by placing the samples into a plurality of receptacles, the receptacles being formed by placing an apertured sheet upon the substrate, thereby forming a multi-layered casting assembly and plurality of receptacles.

66. The apparatus of claim 65 wherein said multi-layered casting assembly having sample receiving wells and said plurality of material formulations disposed in the plurality of receptacles, is placed into a centrifuge and subjected to a centrifugal force.

67. The apparatus of claim 59 wherein the probe has a geometric shape.

68. The apparatus of claim 59 wherein said apparatus has a plurality of probes.

69. The apparatus of claim 59 or 68, wherein the probe(s) are articulated.

70. The apparatus of claim 59 or 68 wherein said probe(s) has a plurality of raised probing surfaces.

71. The apparatus of claim 65 wherein the multi-layered casting assembly, having a plurality of receiving receptacles, is flexible.

72. The apparatus of claim 59 wherein the probe is spherical.

73. The apparatus of claim 65 wherein the multi-layered casting assembly in positioned within a chamber of the centrifuge, the chamber having a variable atmosphere.

74. The apparatus of claim 59 wherein the apparatus is placed in an environmental chamber and testing is carried out in the environmental chamber.
